(19) United States
(12) Patent Application Publication
(10) Pub. No.: US 2018/0352924 A1
(43) Pub. Date: Dec. 13, 2018

(54) IMPROVED PROTECTIVE CASE FOR OUT-FOLDING IMAGE DISPLAY DEVICE PROVIDED WITH FLEXIBLE DISPLAY DEVICE, AND PROTECTIVE CASE APPLICATION METHOD

(71) Applicant: You Seob Lim, Goyang-si (KR)

(72) Inventor: You Seob Lim, Goyang-si (KR)

(21) Appl. No.: 15/748,604

(22) PCT Filed: Aug. 3, 2016
(86) PCT No.: PCT/KR2016/008574

§ 371 Date: Jan. 29, 2018

(30) Foreign Application Priority Data
Aug. 3, 2015 (KR) 10-2015-0109280
Aug. 1, 2016 (KR) PCT/KR2016/008460
Aug. 3, 2016 (KR) 10-2016-0098862

(51) Int. Cl. A45C 11/00; H04B 1/3888

(52) U.S. Cl. CPC A45C 11/00; A45C 2011/003; A45C 2011/002; H04B 1/3888

(57) ABSTRACT

The present invention relates to an improved protective case which is applied to an out-folding image display device, the circumferential shape of which changes by the folding or unfolding rotation about a folding axis part of a flexible display device, unlike existing plate-shaped image display devices having an unchangeable circumferential shape, and to an improved protective case which improves a user's one-hand manipulation, with the protective case unfolded, by minimizing a part for maintaining the unfolding of the protective case in case an out-folding image display device is unfolded, and can perform the bumper function of limitedly absorbing impacts on a circumferential part inflicted when the out-folding image display device is dropped, as well as performing a cover plate function such as the prevention of the scratching of the flexible display device.

### TECHNICAL FIELD

The present invention relates to a protective case applied to prevent breakage, scratch, dent, bag damage and the like generated by an impact of an out-folding image display device provided with a flexible display device, and more specifically, to an improved case of an out-folding image display device, which does not restrict folding and unfolding of a flexible display device, makes user's one-hand grip easy by maintaining a minimized state of the protective case when an unfolded state is changed, and applies a shape of latching a finger to help unfolding an out-folding image display device of a folded state.

### BACKGROUND ART

Due to generalization of shape-invariant image display devices such as existing plate-shaped smart phones and tablet devices, additional products such as a bumper case for preventing damage of a liquid crystal display screen from an impact (Korean Patent Registration No. 10-1229079), a diary type case capable of storing an image display device in an inner space of a diary type cover and having a function of storing credit cards (Korean Patent Registration No. 10-1192287, Korean Utility Model Registration No. 30-0473451), and a bumper-integrated case combining the functions of the bumper case and the diary type case (Korean Utility Model Registration No. 20-0460260) are widely used, and various patents are presented in relation thereto.

A bumper case product is fixed while wrapping the circumference of an existing shape-invariant image display device product, such as a smart phone or a tablet computer, without a discontinued portion, in which the top surface for displaying a screen is formed open from the circumference to enable touch handling and screen display, and a surface on the opposite side of the surface for displaying a screen is formed closed or open by extending the circumference.

A diary type case is configured of a bottom surface fixing plate tightly fixed or assembled to be fixed on a surface on the opposite side of the screen display surface of an existing shape-invariant image display device product such as a smart phone or a tablet computer, a rotating connection plate formed by extending an end portion of the bottom surface fixing plate or adhesively connecting an end portion to an end portion of the bottom surface fixing plate, and a top surface cover plate formed to be extended or adhesively connected to an end portion on the opposite side of the rotating connection plate to selectively cover the screen display surface, and pockets for storing credit cards are formed on the inner surface of the top surface cover plate.

A bumper-integrated case combining a bumper case and a diary type case is fixed while seamlessly wrapping the circumference of an existing shape-invariant image display device product, such as a smart phone or a tablet computer, in which the top surface for displaying a screen is formed open from the circumference, and a surface on the opposite side, which does not display a screen, is configured of a bumper bottom plate fixed on a surface on the opposite side of the screen display surface of the shape-invariant image display device, a rotating connection plate 2 formed to adhesively fix an end portion to the surface of the bumper bottom plate, and a top surface cover plate 2 connected to an end portion of the rotating connection plate 2 to selectively cover the screen display surface.

All the existing bumper case, diary type case and bumper-integrated case are plate-shaped and proposed to be applied to a shape-invariant image display device and may not be applied to an out-folding image display device in which the circumferential shape is changed as folding and unfolding of a flexible display device are performed by hinge axis rotation.

To solve these problems, various protective cases capable of being applied to an out-folding image display device, the circumferential shape of which is changed as folding and unfolding of a flexible display device is performed, have been present by the inventor of the present invention. (Korean Patent application No. 10-2015-0109280)

### DISCLOSURE OF INVENTION

### Technical Problem

The problems to be solved by the present invention are as shown below.

First, an object of the present invention is to provide an improved protective case applied to an out-folding image display device having a folding axis part, which can improve convenience of user's one-hand grip handling without being troubled while the protective case is in an unfolded state by maintaining a minimized state of the protective case when the out-folding image display device is changed to an unfolded state.

Second, an object of the present invention is to provide an improved protective case, which can be fixed by itself without applying a specialized component for fixing the protective case to a symmetric out-folding image display device, in which the size of the folding axis part performing folding and unfolding is unavoidably changed regardless of applying a hinge, and can freely perform folding and unfolding of a flexible display device around the folding axis part without being interfered.

Third, an object of the present invention is to provide an improved protective case applied to a symmetric out-folding image display device, which can perform a limited bumper function of absorbing impacts on a circumferential portion generated when the out-folding image display device is dropped, as well as performing a cover plate function such as preventing a flexible display device from being scratched.

Fourth, an object of the present invention is to provide an improved protective case applied to an out-folding image display device, to which a self-unfolding function is not applied, to perform unfold handling of a user more easily.

Fifth, an object of the present invention is to provide an improved protective case, which can minimize and selectively protect only essential protection portions while saving the design by exposing the outer appearance of an out-folding image display device to the maximum, maintain an released and minimized state so that convenience of user's one-hand grip handling is not disturbed when protection release or unfold handling is performed, and perform touch handling and expose image display on any one of front and rear surfaces of a flexible device stored in a folded state while being applied to the out-folding image display device of a folded state.

### Technical Solution

To accomplish the objects, in a case of an out-folding image display device of a first embodiment of the present invention configured to include a bottom open cover, although corresponding to the bottom surface fixing plate fixed on the opposite side of the screen display surface of a diary type case applied to the shape-invariant image display device, not being fixed to be unable to rotate and selectively covering, in a rotatable state, a foldable and securable display part of the out-folding image display device having a folding axis part where folding occurs, the case of an out-folding image display device may be configured to include a bottom open cover which does not simply rotate and stay at the outside of the area of the out-folding image display device when the out-folding image display device is changed to an unfolded state, but is multi-folded or rolled around using an end portion positioned at the folding axis part as a rolling axis and maintained in a minimized state at an edge on the opposite side facing the folding axis part of the out-folding image display device.

The case of an out-folding image display device of the first embodiment may be configured to include a curved surface cover formed by extending a portion positioning at an end of the folding axis part of the bottom open cover or assembled as a separate component to selectively cover a curved surface shape portion of a flexible display device formed when the out-folding image display device is folded.

The curved surface cover may be configured to include: a protection frame formed across the end portion of the free edge to prevent occurrence of injury to a user's finger and occurrence of damage to the flexible display device caused by an edge or a corner formed at the end portion of the free edge of the curved surface cover; and a bumper shape formed at the top and bottom edges of the curved surface cover so that the top and bottom edge portions of the curved surface cover may prevent occurrence of damage to the out-folding image display device caused by a dropping impact when the out-folding image display device of a folded state is dropped.

The curved surface cover may be configured to include a pulling means formed at a predetermined portion positioning at the free edge of the curved surface cover so that a user may easily unfold the bottom open cover and the curved surface cover stored in a multi-folded or rolled state.

In the case of an out-folding image display device of the first embodiment, the bottom open cover may be configured to include: folding induction shapes formed to be recessed at regular intervals so that the bottom open cover capable of being multi-folded may be folded in the form of a folding screen at predetermined positions; or a folding plate configuring a component of the bottom open cover as a plurality of plates having a width considering a multi-fold width is fixed to the inside or outside at regular intervals so that folding may be performed in the form of a folding screen at predetermined positions.

In a second embodiment, which is another embodiment of the present invention, the case of an out-folding image display device may be configured to include: a storage housing applied to an edge portion on the opposite side of the folding axis part of the out-folding image display device having the folding axis part where folding of the flexible display device occurs and having a rolling axis and a storage space for a rolling target; and a bottom open cover, although corresponding to the bottom surface fixing plate fixed on the opposite side of the screen display surface of a diary type case applied to the shape-invariant image display device, capable of covering the foldable and securable display part of the out-folding image display device in a folded state or maintaining a state of being rolled and stored in the storage housing as an end portion of one side is connected to the rolling axis of the storage housing, and an end portion of the opposite side is spread to get out of the storage housing.

In a second embodiment, the case of an out-folding image display device may be configured to include a curved surface cover formed to be extended at the end portion of the free edge on the opposite side of the bottom open cover connected to the rolling axis to selectively cover the curved surface shape portion of the flexible display device formed when the out-folding image display device is folded in case of an unfolding state and to be sequentially rolled together with the bottom open cover and stored in the storage housing in a rolled state except the end portion of the free edge in case of a rolling state, and the curved surface cover may be configured to include a protection frame formed across the end portion of the free edge to prevent injury to a user's finger, prevent damage to the flexible display device, and form an end portion latch at the outside of the outlet of the storage housing for an unfolding process.

As another example of the curved surface cover that can be applied to the second embodiment, the case of an out-folding image display device may be configured to include a curved surface cover formed to be extended or assembled using a separate component at the end portion of the free edge on the opposite side of the bottom open cover connected to the rolling axis to selectively cover the curved surface shape portion of the flexible display device formed when the out-folding image display device is folded in case of an unfolding state, and to be maintained in an unrolled state outside the storage housing unlike the bottom open cover in case of a rolling state, and the curved surface cover may be configured to include: a protection frame formed across the end portion of the free edge to prevent injury to a user's finger and prevent damage to the flexible display device caused by an edge or a corner formed at the end portion of the free edge of the curved surface cover; and a bumper shape formed at the top and bottom edges of the curved surface cover so that the top and bottom edge portions of the curved surface cover may prevent occurrence of damage to the out-folding image display device caused by a dropping impact when the out-folding image display device of a folded state is dropped. In the second embodiment, the case of an out-folding image display device may be configured to include a pulling means such as a pulling strip connected to a penetration hole formed at a predetermined portion positioning at the free edge of the curved surface cover so that a user may easily unfold the portion stored in the storage housing in a rolled state.

A third embodiment, which is another embodiment of the present invention, is a case of an out-folding image display device having a folding axis part where folding occurs, and it includes an independent curved surface cover independently applied without a separate component for protecting a screen display surface of a plane state of the out-folding image display device and for fixing the case, fixed to the folding axis part when the out-folding image display device is in a folded state to selectively cover and protect the curved surface shape portion of the flexible display device, and released from the folding axis part when the unfolded state of the out-folding image display device is changed.

In the third embodiment, the independent curved surface cover may be configured to include: a bumper shape formed at the edges of the curved surface cover so that the edge portions of the curved surface cover may prevent occurrence of damage to the out-folding image display device caused by a dropping impact when the out-folding image display device of a folded state is dropped, and a loss preventing connection strip, one end of which is connected to the out-folding image display device, and the other end of which is connected to the independent curved surface cover so that the independent curved surface cover released from the folding axis part may not be separated and lost without being connected to the out-folding image display device when the unfolded state of the out-folding image display device is changed.

In the third embodiment, the independent curved surface cover may be configured to include an axis direction closed surface formed at both ends positioning in the direction of the folding axis part of the independent curved surface cover by closing the top edge and the bottom edge of the independent curved surface cover so that the independent curved surface cover may not slide and deviate in the direction of the folding axis part.

As another application example of the independent curved surface cover that can be applied to the third embodiment, when the independent curved surface cover is released and separated from the folding axis part of the out-folding image display device, both end portions of the independent curved surface cover are contracted facing each other in the direction of the folding axis part to occupy a minimum space, and when the independent curved surface cover is applied to be fixed to the folding axis part, it may be expanded and fixed in the direction of the folding axis part as the user fixes by latching an end portion and pulling the other end portion.

A fourth embodiment, which is another embodiment of the present invention, is a case of an out-folding image display device having a folding axis part where folding occurs, and it is configured to include an integrated front side opening cover, in which a screen display surface penetration hole for exposing a screen display capable area of the flexible display device applied to the out-folding image display device is formed, and both portions on the left and right sides of the folding axis part configuring the portions excluding the screen display surface penetration hole are tightly fixed, in an integrated form, on the outer surface of the out-folding image display device to which the flexible display device is fixed.

In the fourth embodiment, the case of an out-folding image display device may be configured to include a bottom open cover formed to be extended or separately assembled at an edge on the opposite side facing the folding axis part to selectively cover the foldable and securable display part of the out-folding image display device. In the fourth embodiment, the integrated front side opening cover may be configured to include: an unfold handling penetration hole formed to pass through a side positioned at an edge on the opposite side facing the folding axis part of the integrated front side opening cover; an upper finger latching step formed to be protruded at both ends of the edge where the unfold handling penetration hole is formed, among the edges on the opposite side facing the folding axis part, so that a finger may be easily latched to apply an unfolding force; and a lower finger latching step formed on an edge where the unfold handling penetration hole is not formed, among the edges on the opposite side facing the folding axis part, so that remaining fingers not latched to the upper finger latching step may transfer a latching force related unfolding in the opposite direction by way of the unfold handling penetration hole.

In the fourth embodiment, the integrated front side opening cover may be configured to include: a bumper protrusion formed to have a predetermined length by extending the circumferential area of the out-folding image display device from the top and bottom corner areas of the edges facing the folding axis part, among the corner portions of the integrated front side opening cover, toward the outside of the circumferential area of the out-folding image display device; and a bumper protrusion supporting surface formed to be extended across a predetermined range in a direction perpendicular to the direction of the bumper protrusion formed to be extended so that the portion starting the extended formation of the bumper protrusion may be fixed to the top surface and the bottom surface of the out-folding image display device perpendicular to the folding axis part. In the fourth embodiment, a portion related to the folding axis part and corresponding to a variable circumferential area where circumferential length is changed when the folding axis part is folded and unfolded, among the portions of the integrated front side opening cover, is not directly fixed to the out-folding image display device, but indirectly fixed through directly fixed adjacent portions, absorb changes of the circumferential length.

The integrated front side opening cover may be formed of an elastic material or a portion corresponding to the variable circumferential area may have a wrinkle shape so that the portion corresponding to the variable circumferential area, among the portions of the integrated front side opening cover, may absorb the change of the circumferential length.

A fifth embodiment, which is another embodiment of the present invention, is a case of an out-folding image display device having a folding axis part where folding occurs, and it is configured to include: an integrated front side opening cover, in which a screen display surface penetration hole for exposing a screen display capable area of the flexible display device applied to the out-folding image display device is formed, and both portions on the left and right sides of the folding axis part configuring the portions excluding the screen display surface penetration hole are tightly fixed, in an integrated form, on the outer surface of the out-folding image display device to which the flexible display device is fixed, and a protection film for closing the screen display surface penetration hole of the integrated front side opening cover, being fixed to the circumference of the screen display surface penetration hole, protecting the flexible display device, and allowing transmission of the display screen.

In the fifth embodiment, the protection film may be formed of an elastic material absorb changes of the circumferential length when the folding axis part is folded and unfolded.

In the fifth embodiment, the integrated front side opening cover may be configured to include: an unfold handling penetration hole formed to pass through a side positioned at an edge on the opposite side facing the folding axis part of the integrated front side opening cover; an upper finger latching step formed to be protruded at both ends of the edge where the unfold handling penetration hole is formed, among the edges on the opposite side facing the folding axis part, so that a finger may be easily latched to apply an unfolding force; and a lower finger latching step formed on an edge where the unfold handling penetration hole is not formed, among the edges on the opposite side facing the folding axis part, so that remaining fingers not latched to the upper finger latching step may transfer a latching force related unfolding in the opposite direction by way of the unfold handling penetration hole.

In the fifth embodiment, the integrated front side opening cover may be configured to include: a bumper protrusion formed to have a predetermined length by extending the circumferential area of the out-folding image display device from the top and bottom corner areas of the edges facing the folding axis part, among the corner portions of the integrated front side opening cover, toward the outside of the circumferential area of the out-folding image display device; and a bumper protrusion supporting surface formed to be extended across a predetermined range in a direction perpendicular to the direction of the bumper protrusion formed to be extended so that the portion starting the extended formation of the bumper protrusion may be fixed to the top surface and the bottom surface of the out-folding image display device perpendicular to the folding axis part. In the fifth embodiment, a portion related to the folding axis part and corresponding to a variable circumferential area where circumferential length is changed when the folding axis part is folded and unfolded, among the portions of the integrated front side opening cover, is not directly fixed to the out-folding image display device, but indirectly fixed through directly fixed adjacent portions, absorb changes of the circumferential length.

The integrated front side opening cover may be formed of an elastic material so that the portion corresponding to the variable circumferential area, among the portions of the integrated front side opening cover, may absorb the change of the circumferential length.

A sixth embodiment, which is another embodiment of the present invention, is a case of an out-folding image display device having a folding axis part where folding occurs, and it may be configured to include: a horizontally separable front cover, in which a screen display surface opening for exposing a screen display capable area of the flexible display device applied to the out-folding image display device is formed in both portions on the left and right sides of the folding axis part, and the portions excluding the screen display surface opening are tightly fixed, while the portions on the left and right sides of the folding axis part are separated, on the outer surface of the out-folding image display device to which the flexible display device is fixed; and a variable connection cover applied to the variable circumferential area where circumferential length is changed when the folding axis part is folded and unfolded, which is a portion to which the horizontally separable front cover is not applied.

In the sixth embodiment, the case of an out-folding image display device may be configured to include a bottom open cover formed to be extended or separately assembled at an edge on the opposite side facing the folding axis part to selectively cover the foldable and securable display part of the out-folding image display device. In the sixth embodiment, the horizontally separable front side opening cover may be configured to include: an unfold handling penetration hole formed to pass through a side positioned at an edge on the opposite side facing the folding axis part of the horizontally separable front side opening cover; an upper finger latching step formed to be protruded at both ends of the edge where the unfold handling penetration hole is formed, among the edges on the opposite side facing the folding axis part, so that a finger may be easily latched to apply an unfolding force; and a lower finger latching step formed on an edge where the unfold handling penetration hole is not formed, among the edges on the opposite side facing the folding axis part, so that remaining fingers not latched to the upper finger latching step may transfer a latching force related unfolding in the opposite direction by way of the unfold handling penetration hole.

In the sixth embodiment, the horizontally separable front side opening cover may be configured to include: a bumper protrusion formed to have a predetermined length by extending the circumferential area of the out-folding image display device from the top and bottom corner areas of the edges facing the folding axis part, among the corner portions of the horizontally separable front side opening cover, toward the outside of the circumferential area of the out-folding image display device; and a bumper protrusion supporting surface formed to be extended across a predetermined range in a direction perpendicular to the direction of the bumper protrusion formed to be extended so that the portion starting the extended formation of the bumper protrusion may be fixed to the top surface and the bottom surface of the out-folding image display device perpendicular to the folding axis part.

In the sixth embodiment, the variable connection cover is applied between both ends of the horizontally separable front side opening cover of an isolated state and may be formed of an elastic material absorb changes of the circumferential length when the folding axis part is folded and unfolded.

A seventh embodiment, which is another embodiment of the present invention, is a case of an out-folding image display device having a folding axis part where folding occurs, and it may be configured to include: a horizontally separable front cover, in which a screen display surface opening for exposing a screen display capable area of the flexible display device applied to the out-folding image display device is formed in the portions on the left and right sides of the folding axis part, and the portions excluding the screen display surface opening are tightly fixed, while the portions on the left and right sides of the folding axis part are separated, on the outer surface of the out-folding image display device to which the flexible display device is fixed; a variable connection cover applied to the variable circumferential area where circumferential length is changed when the folding axis part is folded and unfolded, which is a portion to which the horizontally separable front cover is not applied; and a protection film for closing a virtual screen display capable area formed by the screen display surface openings on both sides separated by the fixing axis, being fixed to the circumference of the screen display surface openings on both sides, protecting the flexible display device, and allowing transmission of the display screen.

In the seventh embodiment, the protection film may be formed of an elastic material absorb changes of the circumferential length when the folding axis part is folded and unfolded.

In the seventh embodiment, the horizontally separable front cover may be configured to include: an unfold handling penetration hole formed to pass through a side positioned at an edge on the opposite side facing the folding axis part of the horizontally separable front side opening cover; an upper finger latching step formed to be protruded at both ends of the edge where the unfold handling penetration hole is formed, among the edges on the opposite side facing the folding axis part, so that a finger may be easily latched to apply an unfolding force; and a lower finger latching step formed on an edge where the unfold handling penetration hole is not formed, among the edges on the opposite side facing the folding axis part, so that remaining fingers not latched to the upper finger latching step may transfer a latching force related unfolding in the opposite direction by way of the unfold handling penetration hole.

In the seventh embodiment, the horizontally separable front cover may be configured to include: a bumper protrusion formed to have a predetermined length by extending the circumferential area of the out-folding image display device from the top and bottom corner areas of the edges facing the folding axis part, among the corner portions of the horizontally separable front cover, toward the outside of the circumferential area of the out-folding image display device; and a bumper protrusion supporting surface formed to be extended across a predetermined range in a direction perpendicular to the direction of the bumper protrusion formed to be extended so that the portion starting the extended formation of the bumper protrusion may be fixed to the top surface and the bottom surface of the out-folding image display device perpendicular to the folding axis part.

In the seventh embodiment, the variable connection cover is applied between both ends of the horizontally separable front side opening cover of an isolated state and may be formed of an elastic material absorb changes of the circumferential length when the folding axis part is folded and unfolded.

An eighth embodiment, which is another embodiment of the present invention, is a case of an out-folding image display device having a folding axis part where folding occurs, and it may be configured to include a vertically separable front cover, in which a portion formed to be separated into an upper portion and a lower portion, as the area between the upper and lower edges of the screen display capable area is extended and removed to expose the screen display capable area of the flexible display device applied to the out-folding image display device, is tightly fixed on the outer surface of the out-folding image display device to which the flexible display device is fixed while the upper and lower edges separated.

In the eighth embodiment, a portion related to the folding axis part and corresponding to a variable circumferential area where circumferential length is changed when the folding axis part is folded and unfolded, among the portions of the vertically separable front cover, is not directly fixed to the out-folding image display device, but indirectly fixed through directly fixed adjacent portions, absorb changes of the circumferential length.

In the eighth embodiment, the vertically separable front cover may be formed of an elastic material or a portion corresponding to the variable circumferential area may have a wrinkle shape so that the portion corresponding to the variable circumferential area, among the portions of the vertically separable front cover, may absorb the change of the circumferential length.

In the eighth embodiment, the vertically separable front cover is configured to include: a bumper protrusion formed to have a predetermined length by extending the circumferential area of the out-folding image display device from the top and bottom corner areas of the edges facing the folding axis part, among the corner portions of the vertically separable front cover, toward the outside of the circumferential area of the out-folding image display device; and a bumper protrusion supporting surface formed to be extended across a predetermined range in a direction perpendicular to the direction of the bumper protrusion formed to be extended so that the portion starting the extended formation of the bumper protrusion may be fixed to the top surface and the bottom surface of the out-folding image display device perpendicular to the folding axis part.

In the eighth embodiment, the case of an out-folding image display device is configured to include: an independent curved surface cover fixed to the folding axis part when the out-folding image display device is in a folded state to selectively cover and protect the curved surface shape portion of the flexible display device and released from the folding axis part when the unfolded state of the out-folding image display device is changed; and a loss preventing connection strip, one end of which is connected to the independent curved surface cover, and the other end of which is connected to the vertically separable front cover or the out-folding image display device.

A ninth embodiment, which is another embodiment of the present invention, is a case of an out-folding image display device having a folding axis part where folding occurs, and it is configured to include an edge separable cover tightly fixed to the adjacent portions of facing edges positioned on the opposite sides of the folding axis part of the out-folding image display device in a separated state to expose the screen display capable area of the flexible display device applied to the out-folding image display device.

In the ninth embodiment, the edge separable cover is configured to include a finger latching shape formed on an edge of one side, among the edges on the opposite sides facing the folding axis part of the edge separable cover, so that a finger may be easily latched to apply an unfolding force and also formed on the other edge of the opposite sides facing the folding axis part so that unlatched remaining fingers may transfer a latching force related unfolding in the opposite direction.

In the ninth embodiment, the edge separable cover is configured to include: a bumper protrusion formed to have a predetermined length by extending the circumferential area of the out-folding image display device from the top and bottom corner areas of the edges facing the folding axis part, among the corner portions of the edge separable cover, toward the outside of the circumferential area of the out-folding image display device; and a bumper protrusion supporting surface formed to be extended across a predetermined range in a direction perpendicular to the direction of the bumper protrusion formed to be extended so that the portion starting the extended formation of the bumper protrusion may be fixed to the top surface and the bottom surface of the out-folding image display device perpendicular to the folding axis part. In the ninth embodiment, the case of an out-folding image display device is configured to include: an independent curved surface cover or fixed to the folding axis part when the out-folding image display device is in a folded state to selectively cover and protect the curved surface shape portion of the flexible display device and released from the folding axis part when the unfolded state of the out-folding image display device is changed; and a loss preventing connection strip, one end of which is connected to the independent curved surface cover, and the other end of which is connected to the edge separable cover or the out-folding image display device.

A tenth embodiment, which is another embodiment of the present invention, is a case of an out-folding image display device having a folding axis part where folding occurs, and it is configured to include a corner separable cover tightly fixed to the upper and lower corner portions of facing edges positioned on the opposite sides of the folding axis part of the out-folding image display device in a separated state to expose the screen display capable area of the flexible display device applied to the out-folding image display device.

In the tenth embodiment, the corner separable cover is configured to include: a bumper protrusion formed to have a predetermined length by extending the circumferential area of the out-folding image display device from the top and bottom corner areas of the edges facing the folding axis part, among the corner portions of the corner separable cover, toward the outside of the circumferential area of the out-folding image display device; and a bumper protrusion supporting surface formed to be extended across a predetermined range in a direction perpendicular to the direction of the bumper protrusion formed to be extended so that the portion starting the extended formation of the bumper protrusion may be fixed to the top surface and the bottom surface of the out-folding image display device perpendicular to the folding axis part.

In the tenth embodiment, the case of an out-folding image display device is configured to include: an independent curved surface cover fixed to the folding axis part when the out-folding image display device is in a folded state to selectively cover and protect the curved surface shape portion of the flexible display device and released from the folding axis part when the unfolded state of the out-folding image display device is changed; and a loss preventing connection strip, one end of which is connected to the independent curved surface cover, and the other end of which is connected to the corner separable cover or the out-folding image display device.

### Advantageous Effects

As described above, according to the embodiments of the present invention, the present invention has advantages other than the advantages of the protective case patents previously applied by the inventor of the present invention.

First, since the improved protective case applied to an out-folding image display device is not unfolded and spread toward the outside of the out-folding image display device area and is multi-folded or rolled and maintained in a minimized state on an edge on the opposite side of the unfolding axis part when the out-folding image display device is changed to an unfolded state, convenience of user's one-hand grip handling in an unfolded state is improved regardless of applying a protective case.

Second, since the improved protective case applied to a symmetric out-folding image display device, in which the size of the folding axis part performing folding and unfolding is unavoidably changed regardless of applying a hinge, is fixed to the out-folding image display device by itself while being adapted to the change of size of the folding axis part, a phenomenon of tearing the protective case or floating the protective case generated due to non-absorption of marginal portions does not occur.

Third, since the improved protective case is applied to a symmetric out-folding image display device to which a bumper case is difficult to be applied, a bumper function of limitedly absorbing impacts on a circumferential portion generated when the out-folding image display device is dropped can be performed together with a cover plate function such as preventing a flexible display device from being scratched.

Fourth, when unfolding of an out-folding image display device lacking of a self-unfolding function is performed, the unfold handling of a user can be performed more easily through a protective case to which a shape capable of latching a finger is applied.

Fifth, since only the essential protection portions are minimized and selectively protected while saving the design by exposing the outer appearance of the out-folding image display device to the maximum, high quality as a premium product, convenience of touch handling and usability of a folded screen can be maximized.

### BRIEF DESCRIPTION OF THE DRAWINGS

FIG. 1 is an exemplary view and an assembly view showing a circular bumper case applied to a shape-invariant image display device without a folding function.

FIG. 2 is an exemplary view and an assembly view showing a diary type case applied to a shape-invariant image display device without a folding function.

FIG. 3 is an exemplary view and an assembly view showing a bumper-integrated case applied to a shape-invariant image display device without a folding function.

FIG. 4 is plan views and front views showing folded and unfolded states of an asymmetric out-folding image display device.

FIG. 5 is plan views and front views showing folded and unfolded states of a symmetric out-folding image display device.

FIG. 6 is a plan view and a front view showing a case of an out-folding image display device including a bottom open cover not being multi-folded or rolled and applied to an asymmetric out-folding image display device.

FIG. 7 is perspective views showing folded and unfolded states of a case of an out-folding image display device including a bottom open cover not being multi-folded or rolled and applied a symmetric out-folding image display device.

FIG. 8 is a plan view and a front view showing an unfolded state of a case of an asymmetric out-folding image display device including a multi-folded bottom open cover applied to the asymmetric out-folding image display device.

FIG. 9 is a detailed view showing Detail A of FIG. 8.

FIG. 10 is a conceptual view showing a folding induction shape formed in a bottom open cover.

FIG. 11 is a conceptual view showing a folding plate configuring a bottom open cover.

FIG. 12 is a plan view and a front view showing an unfolded state of a case of an asymmetric out-folding image display device including a rollable bottom open cover applied to the asymmetric out-folding image display device.

FIG. 13 is a detailed view showing Detail B of FIG. 12.

FIG. 14 is a plan view and a front view showing an unfolded state of a case of a symmetric out-folding image display device including a multi-folded bottom open cover applied to the symmetric out-folding image display device.

FIG. 15 is a detailed view showing Detail C of FIG. 14.

FIG. 16 is a cross-sectional view showing Section A-A of FIG. 14.

FIG. 17 is a perspective view showing a storage housing applied to an asymmetric out-folding image display device.

FIG. 18 is a plan view and a front view showing a folded state of a case of an asymmetric out-folding image display device including a storage housing applied to the asymmetric out-folding image display device.

FIG. 19 is a cross-sectional view showing Section B-B of FIG. 18.

FIG. 20 is a plan view and a front view showing an unfolded state of a case of an asymmetric out-folding image display device including a storage housing applied to the asymmetric out-folding image display device.

FIG. 21 is a cross-sectional view showing Section C-C of FIG. 20.

FIG. 22 is a perspective view showing a storage housing applied to a symmetric out-folding image display device.

FIG. 23 is a plan view and a front view showing a folded state of a case of a symmetric out-folding image display device including a storage housing applied to the symmetric out-folding image display device.

FIG. 24 is a cross-sectional view showing Section D-D of FIG. 23.

FIG. 25 is a plan view and a front view showing an unfolded state of a case of a symmetric out-folding image display device including a storage housing applied to the symmetric out-folding image display device.

FIG. 26 is a cross-sectional view showing Section E-E of FIG. 25.

FIG. 27 is a perspective view showing an independent curved surface cover applied to a symmetric out-folding image display device.

FIG. 28 is a plan view and a front view showing a folded state of a case of a symmetric out-folding image display device including an independent curved surface cover applied to the symmetric out-folding image display device.

FIG. 29 is a cross-sectional view showing Section F-F of FIG. 28.

FIG. 30 is a perspective view showing an integrated front side opening cover applied to a symmetric out-folding image display device.

FIG. 31 is a plan view, a side view and a front view showing a folded state of a case of a symmetric out-folding image display device including an integrated front side opening cover applied to the symmetric out-folding image display device.

FIG. 32 is cross-sectional views showing Section F-F, Section G-G, Section H-H, Section I-I, Section J-J and Section K-K of FIG. 31.

FIG. 33 is a plan view and a front view showing an unfolded state of a case of a symmetric out-folding image display device including an integrated front side opening cover applied to the symmetric out-folding image display device.

FIG. 34 is a perspective view showing an unfolded states of a case of a symmetric out-folding image display device including an integrated front side opening cover provided with a bottom open cover.

FIG. 35 is a perspective view showing a horizontally separable front cover applied to a symmetric out-folding image display device.

FIG. 36 is a plan view and a front view showing an unfolded state of a case of a symmetric out-folding image display device including a horizontally separable front cover applied to the symmetric out-folding image display device.

FIG. 37 is a cross-sectional view showing Section L-L of FIG. 36.

FIG. 38 is a perspective view showing a vertically separable front cover applied to a symmetric out-folding image display device.

FIG. 39 is a plan view and a front view showing an unfolded state of a case of a symmetric out-folding image display device including a vertically separable front cover applied to the symmetric out-folding image display device.

FIG. 40 is a perspective view showing an edge separable cover applied to a symmetric out-folding image display device.

FIG. 41 is a plan view and a front view showing an unfolded state of a case of a symmetric out-folding image display device including an edge separable cover applied to the symmetric out-folding image display device.

FIG. 42 is a perspective view showing a corner separable cover applied to a symmetric out-folding image display device.

FIG. 43 is a plan view and a front view showing an unfolded state of a case of a symmetric out-folding image display device including a corner separable cover applied to the symmetric out-folding image display device.

### DESCRIPTION OF SYMBOLS

Symbols of major portions of the accompanying drawings are described as shown below.
10: shape-invariant image display device
11: circular bumper case
12: diary type case
13: top surface cover plate
14: rotating connection plate
15: bottom surface fixing plate
16: bumper-integrated case
17: bumper bottom plate
20: asymmetric out-folding image display device
21: symmetric out-folding image display device
22: fixed screen display part
23: foldable and securable display part
24: protective case fixing hole
25: folding axis part
26: flexible display device
30: open-type bumper case
31: interference removing area
32: corner latching step
33: hinge part latching step
110: bottom open cover
111: folding induction shape
112: folding plate
120: curved surface cover
121: Protection frame
122: bumper shape
123: pulling means
130: top open cover
140: storage housing
150: independent curved surface cover
151: loss preventing connection strip
152: axis direction closed surface
200: integrated front side opening cover
201: screen display surface penetration hole
202: variable circumferential area
203: unfold handling penetration hole
204: upper finger latching step
205: lower finger latching step
206: bumper protrusion
207: bumper protrusion supporting surface
208: winkled shape (not shown)
300: horizontally separable front cover
301: screen display surface opening
302: variable connection cover
400: vertically separable front cover
500: edge separable cover
501: finger latching shape
600: corner separable cover
700: protection film

### Best Mode for Carrying out the Invention

Hereafter, the preferred embodiments of the present invention will be described in detail with reference to the accompanying drawings. The terms used in the specification are used to just describe the embodiments and do not intend to limit the present invention. In the specification, singular forms include plural forms unless the context clearly indicates otherwise. Furthermore, reference symbols presented in the order of the description is not necessarily limited to the specified order.

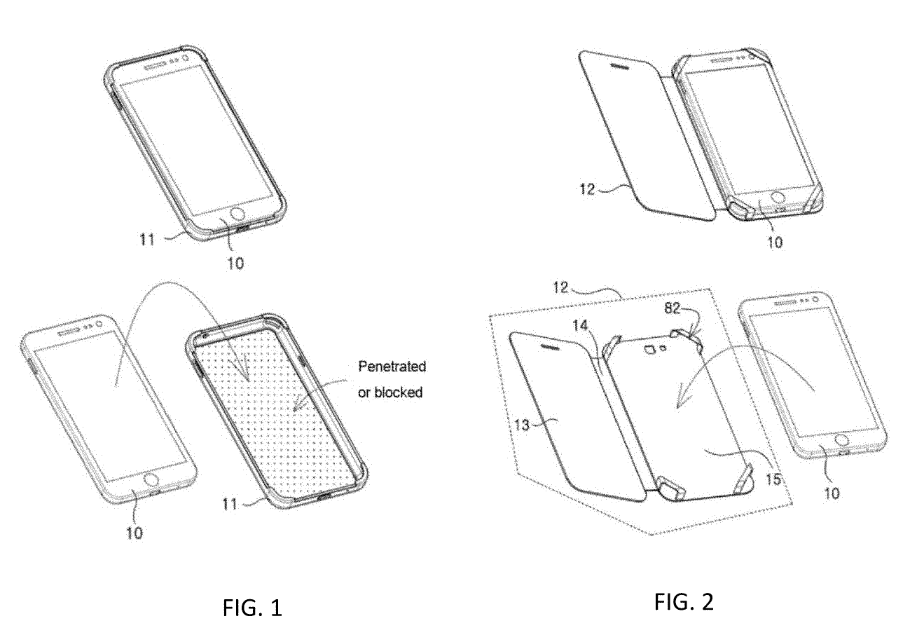

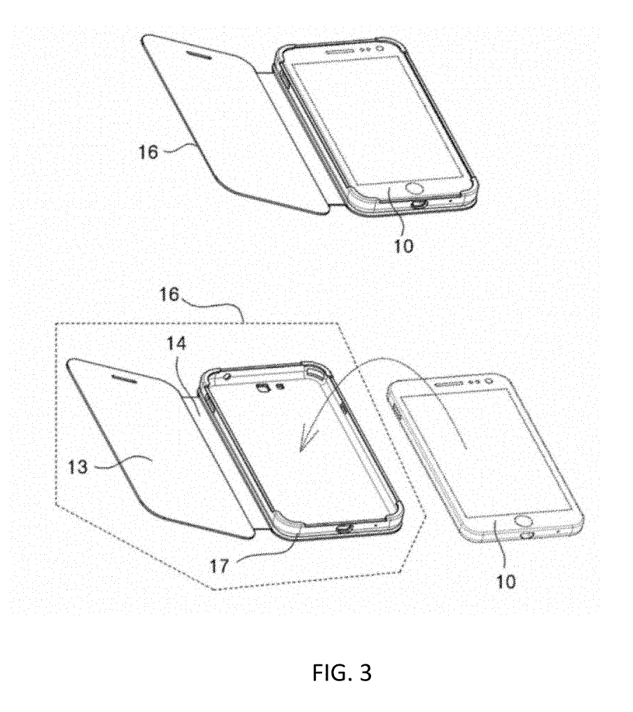

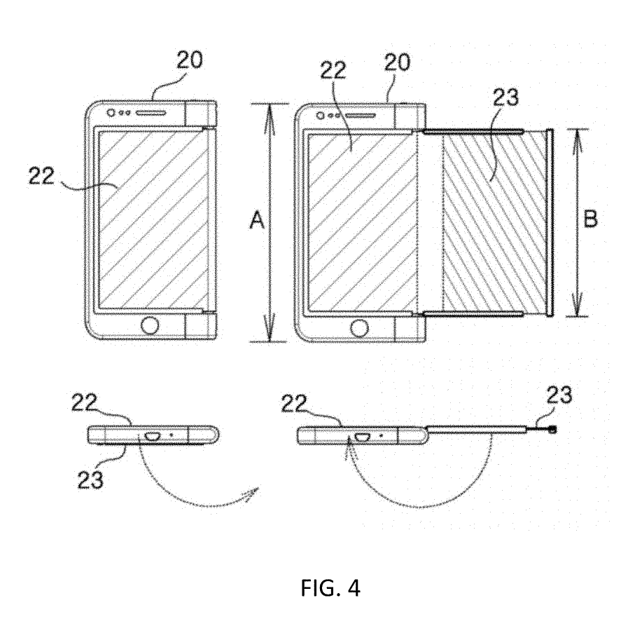

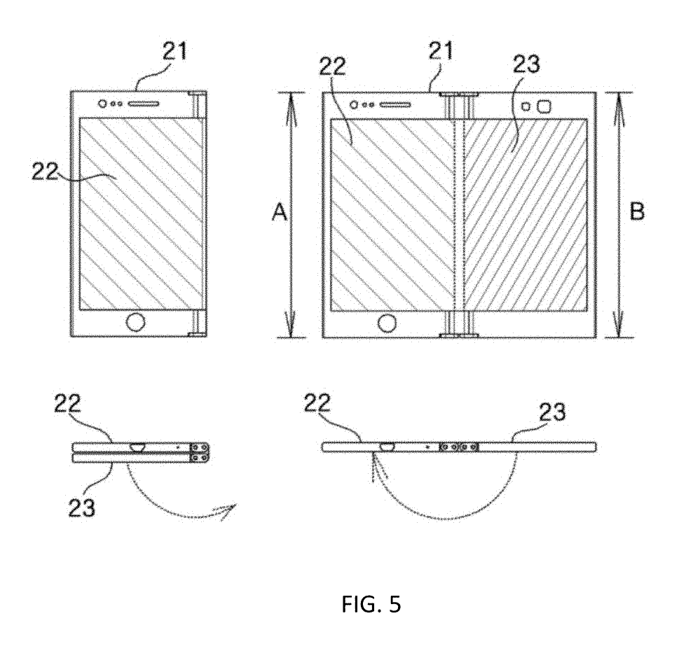

FIG. 1 is an exemplary view and an assembly view showing a circular bumper case applied to a shape-invariant image display device without a folding function, FIG. 2 is an exemplary view and an assembly view showing a diary type case applied to a shape-invariant image display device without a folding function, and FIG. 3 is an exemplary view and an assembly view showing a bumper-integrated case applied to a shape-invariant image display device without a folding function.

As shown in FIGS. 1, 2 and 3, additional products such as a circular bumper case 11 (Korean Patent Registration No. 10-1229079), a diary type case 12 (Korean Patent Registration No. 10-1192287, Korean Utility Model Registration No. 30-0473451) and a bumper-integrated case 16 (Korean Utility Model Registration No. 20-0460260) are widely used in a shape-invariant image display device 10 such as existing plate-shaped smart phones and tablet computers to add a protection or storage function of the shape-invariant image display device 10.

As shown in FIG. 1, a circular bumper case 11 is fixed while wrapping the entire outer circumference of a shape-invariant image display device 10 in the form of circulating the entire circumference without a discontinued portion, and a screen display part is open for easy touch handling and confirmation of screen information.

Since a method of fixing the circular bumper case 11 while wrapping the outer circumference of the shape-invariant image display device 10 in the form of circulating the entire circumference without a discontinued portion is applied, there is a problem in that the circular bumper case 11 cannot be applied to an out-folding image display device, in which the circumferential shape of the image display device is changed as a freely bent flexible display device 26 performs hinge folding and unfolding.

As shown in FIG. 2, a diary type case 12 is configured to include a top surface cover plate 13 rotated by a user to selectively cover a screen display surface of a shape-invariant image display device 10, a rotating connection plate 14 formed by extending an end portion of a rotating axis of the top surface cover plate 13 or adhesively or connectedly fixed to the end portion of the rotating axis of the top surface cover plate 13 using a material easy to unfold and fold without regard to the top surface cover plate 13, and a bottom surface fixing plate 15 incapable of rotating as it is formed by extending an end portion of the rotating connection plate 14 or adhesively connected to an end portion of the rotating connection plate 14, and adhesively fixed on a surface on the opposite side of the screen display surface of the shape-invariant image display device 10 or latched and fixed to the corners by latching bands.

The shape-invariant image display device 10 is fixed to the bottom surface fixing plate 15 in an adhesion method, a latching method using fixing bands, or a screw fixing method of the bottom surface fixing plate 15 using fixing screws on a surface on the opposite side of the screen display surface of the shape-invariant image display device 10.

As shown in FIG. 3, a bumper-integrated case 16 is configured to include a top surface cover plate 13 rotated by a user to selectively cover a screen display surface of a shape-invariant image display device 10, a rotating connection plate 14 formed by extending an end portion of a rotating axis of the top surface cover plate 13 or adhesively connected to the end portion of the rotating axis of the top surface cover plate 13 using a material easy to unfold and fold without regard to the top surface cover plate 13, and a bumper bottom plate 17 incapable of rotating as it is fixed while wrapping the outer circumference of the shape-invariant image display device 10 in the form of circulating the entire circumference without a discontinued portion, and adhesively connected to the rotating connection plate 14 in a state of blocking a surface on the opposite side of the screen display surface although the screen display part is open.

As shown in FIGS. 2 and 3, since the bottom surface fixing plate 15 and the bumper bottom plate 17 are fixed on a surface on the opposite side of the screen display surface of the image display device and configure a structure incapable of opening rotation like the top surface cover plate 13, there is a structural problem in that if the diary type case 12 or the bumper-integrated case 16 is applied to an out-folding image display device, a foldable and securable display part 23 folded and stored inside the bottom surface fixing plate 15 and the bumper bottom plate 17 is constrained in a folded state and cannot be unfolded when the out-folding image display device is hinge-unfolded, due to the bottom surface fixing plate 15 or the bumper bottom plate 17 that cannot perform opening rotation.

Accordingly, unlike the shape-invariant image display device 10, it is understood that the circular bumper case 11, the diary type case 12 and the bumper-integrated case 16 as shown in FIGS. 1, 2 and 3 cannot be applied to an out-folding image display device, the circumferential shape of which is changed when hinge folding and unfolding of a flexible display device is performed, and a separate case is required for the out-folding image display device, and a patent has been applied by the inventor of the present invention (Korean Patent Application No. 10-2015-1019280).

The present invention is presented to solve the problems that have not been solved by the patent applied by the inventor of the present invention (Korean Patent Application No. 10-2015-1019280), and cases for an out-folding image display device will be described in detail through various embodiments.

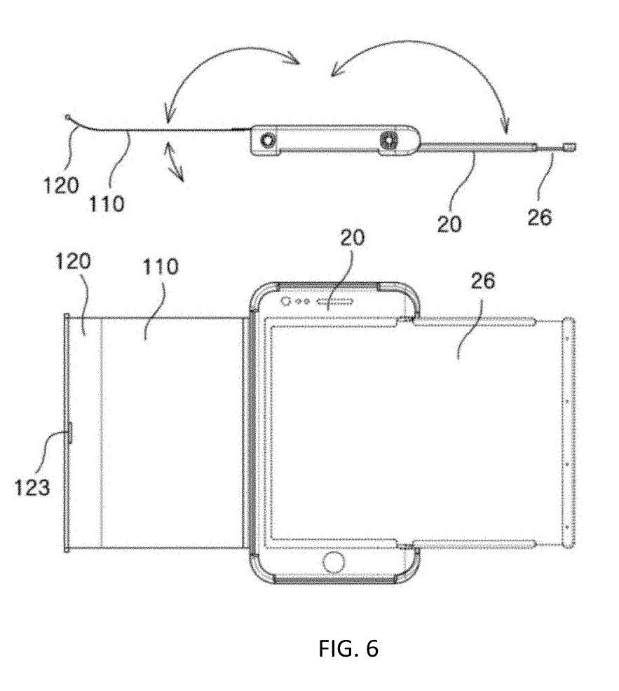

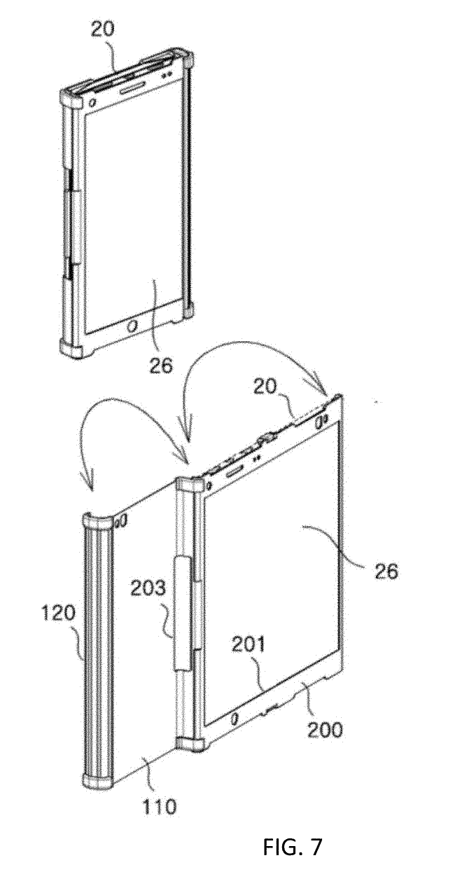

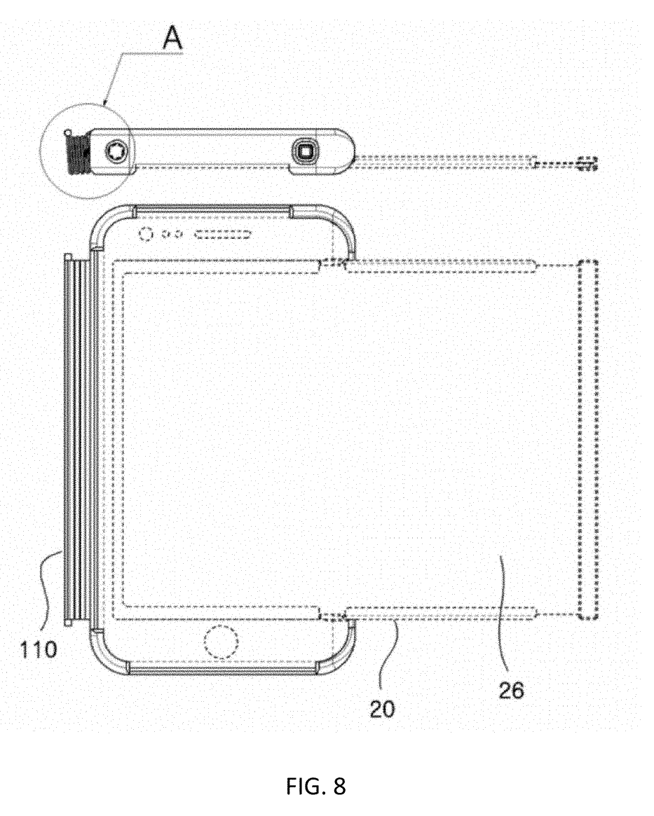

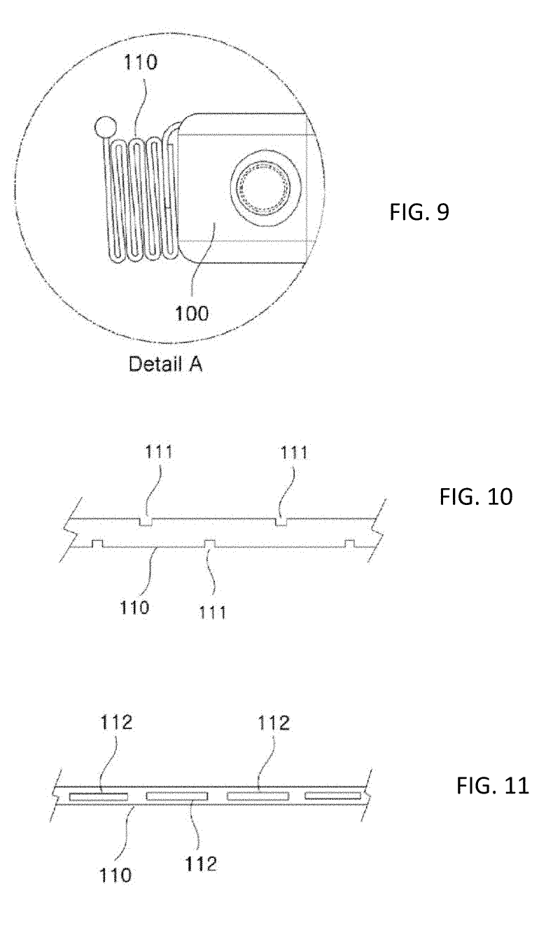

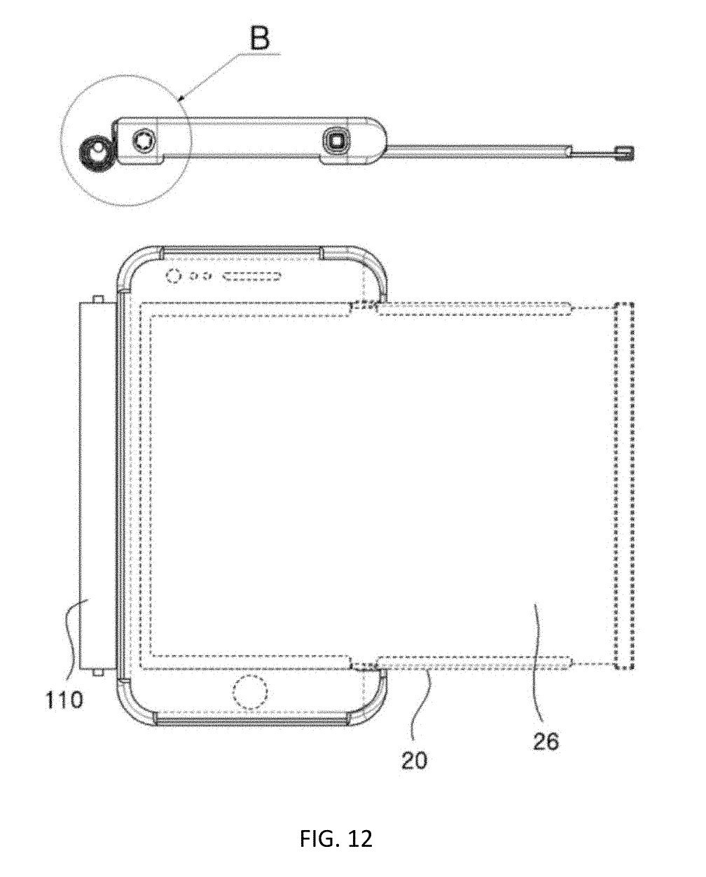

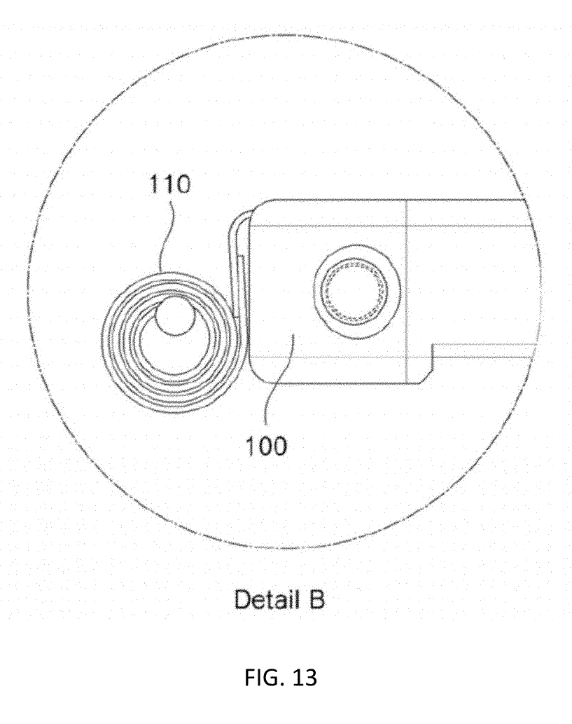

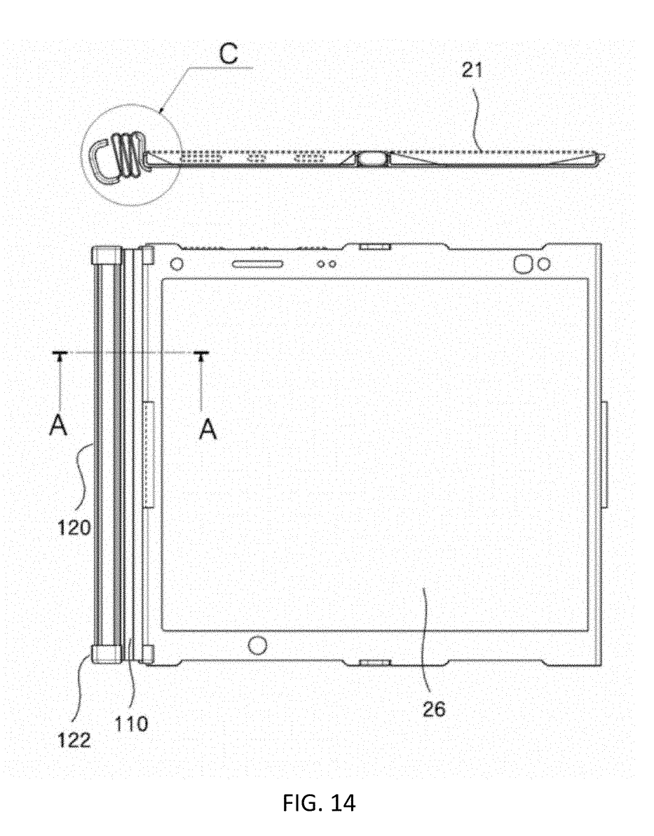

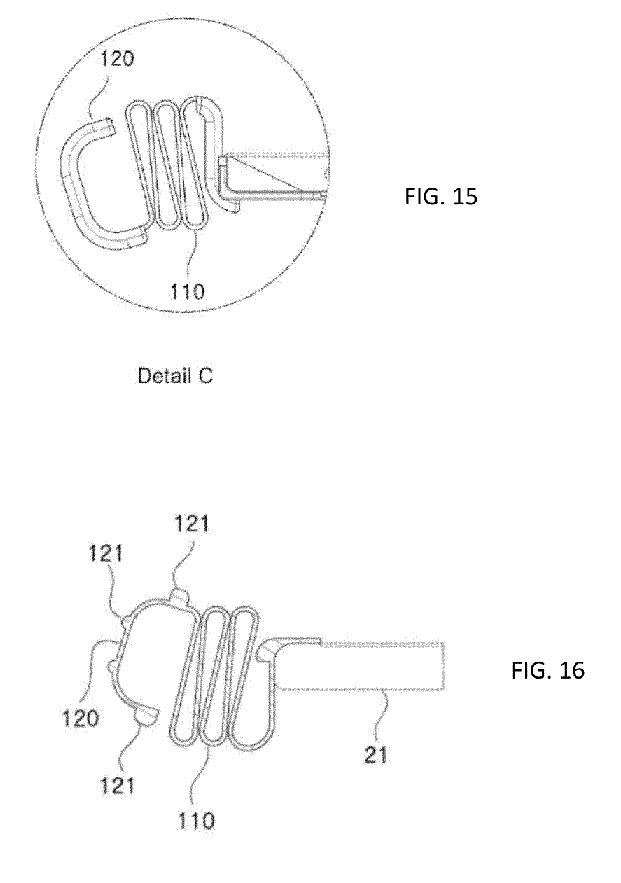

FIG. 6 is a plan view and a front view showing a case of an out-folding image display device including a bottom open cover not being multi-folded or rolled and applied to an asymmetric out-folding image display device, FIG. 7 is perspective views showing folded and unfolded states of a case of an out-folding image display device including a bottom open cover not being multi-folded or rolled and applied a symmetric out-folding image display device, FIG. 8 is a plan view and a front view showing an unfolded state of a case of an asymmetric out-folding image display device including a multi-folded bottom open cover applied to the asymmetric out-folding image display device, FIG. 9 is a detailed view showing Detail A of FIG. 8, FIG. 10 is a conceptual view showing a folding induction shape formed in a bottom open cover, FIG. 11 is a conceptual view showing a folded plate configuring a bottom open cover, FIG. 12 is a plan view and a front view showing an unfolded state of a case of an asymmetric out-folding image display device including a rollable bottom open cover applied to the asymmetric out-folding image display device, FIG. 13 is a detailed view showing Detail B of FIG. 12, FIG. 14 is a plan view and a front view showing an unfolded state of a case of a symmetric out-folding image display device including a multi-folded bottom open cover applied to the symmetric out-folding image display device, FIG. 15 is a detailed view showing Detail C of FIG. 14, and FIG. 16 is a cross-sectional view showing Section A-A of FIG. 14.

As shown in FIGS. 6 and 7, it is understood that if the bottom open cover 110 is not multi-folded or rolled in an unfolded state of the out-folding image display device, the unfolded bottom open cover is maintained in the form of a plate in an area out of an edge on the opposite side of the folding axis 25 part of the out-folding image display device 25. If the bottom open cover 110 is unfolded and maintained in the form of a plate like this, one-hand grip handling that can be felt in the shape-invariant image display device 10 is difficult to do due to the troublesome bottom open cover 110.

A first embodiment of the present invention is presented to solve the problem of convenience of the one-hand grip handling.

In the case of an out-folding image display device of the first embodiment of the present invention configured to include a bottom open cover 110, although corresponding to the bottom surface fixing plate 15 fixed on the opposite side of the screen display surface of a diary type case 12 applied to the shape-invariant image display device 10, not being fixed to be unable to rotate and selectively covering, in a rotatable state, a foldable and securable display part 23 of the out-folding image display device having a folding axis 25 part where folding occurs, the case of an out-folding image display device may be configured to include a bottom open cover 110 which does not simply rotate and stay at the outside of the area of the out-folding image display device when the out-folding image display device is changed to an unfolded state, but is multi-folded or rolled around using an end portion positioned at the folding axis 25 part as a rolling axis and maintained in a minimized state at an edge on the opposite side facing the folding axis 25 part of the out-folding image display device.

The case of an out-folding image display device of the first embodiment may be configured to include a curved surface cover 120 formed by extending a portion positioning at an end of the folding axis 25 part of the bottom open cover 110 or assembled as a separate component to selectively cover a curved surface shape portion of a flexible display device 26 formed when the out-folding image display device is folded.

The curved surface cover 120 may be configured to include: a protection frame 121 formed across the end portion of the free edge to prevent occurrence of injury to a user's finger and occurrence of damage to the flexible display device 26 caused by an edge or a corner formed at the end portion of the free edge of the curved surface cover 120; and a bumper shape 122 formed at the top and bottom edges of the curved surface cover 120 so that the top and bottom edge portions of the curved surface cover 120 may prevent occurrence of damage to the out-folding image display device caused by a dropping impact when the out-folding image display device of a folded state is dropped.

The curved surface cover 120 may be configured to include a pulling means 123 formed at a predetermined portion positioning at the free edge of the curved surface cover 120 so that a user may easily unfold the bottom open cover 110 and the curved surface cover 120 stored in a multi-folded or rolled state.

As shown in FIGS. 10 and 11, in the case of an out-folding image display device of the first embodiment, the bottom open cover 110 may be configured to include: folding induction shapes 111 formed to be recessed at regular intervals so that the bottom open cover 110 capable of being multi-folded may be folded in the form of a folding screen at predetermined positions; or a folding plate 112 configuring a component of the bottom open cover 110 as a plurality of plates having a width considering a multi-fold width is fixed to the inside or outside at regular intervals so that folding may be performed in the form of a folding screen at predetermined positions.

As shown in FIGS. 8 and 14, if the bottom open cover 110 is maintained in a minimized state of being multi-folded on an edge on the opposite side of the folding axis 25 part of the out-folding image display device when the out-folding image display device is in an unfolded state, one-hand grip handling that can be felt in the shape-invariant image display device 10 is allowed.

Generally, the bottom surface fixing plate 15 of the shape-invariant image display device 10 has a feature of a hard material incapable of multi-folding, and furthermore, a folding induction shape 111 allowing all-time folding at a predetermined position is not reflected.

Unlike this, folding induction shapes 111 and a plurality of folded plates 112 having a predetermined width considering a multi-fold width are applied to the bottom open cover 110 of the first embodiment, which allows multi-folding, at regular intervals to allow all-time folding at a predetermined position as shown in the cross-sectional view of the bottom open cover 110 of FIGS. 10 and 11.

FIG. 12 is a plan view and a front view showing an unfolded state of a case of an asymmetric out-folding image display device 20 including a rollable bottom open cover 110 applied to the asymmetric out-folding image display device 20, and FIG. 13 is a detailed view showing Detail B of FIG. 12.

In addition to the multi-folding method as shown in FIG. 8, a rolling method as shown in FIG. 12 may be applied as a method of maintaining the bottom open cover 110 in a minimized state when the out-folding image display device is in an unfolded state.

As shown in FIG. 12, the material of the bottom open cover 110 preferably has a feature of a soft material which allows rolling at all times in order to perform rolling of the bottom open cover 110.

In addition, the material of the bottom open cover 110 also preferably has a feature of a material capable of accumulating elastic force so that the bottom open cover 110, which is opened and rotates when the out-folding image display device is unfolded, may be autonomously rolled and positioned like a rolling spring.

Rolling of the bottom open cover 110 performed as shown in FIG. 13 is accomplished using an end portion of the free edge of the bottom open cover 110 positioned at the folding axis 25 part of the out-folding image display device as a rolling axis.

As shown in FIGS. 8, 12 and 14, the curved surface cover 120 for selectively covering the curved surface shape portion of the flexible display device 26 formed when the out-folding image display device is folded may be formed to be extended at the end portion of the free edge of the bottom open cover 110 which can perform multi-folding or rolling, and as shown in FIGS. 14 and 16, the curved surface cover 120 may be configured to include: a protection frame 121 formed across the end portion of the free edge to prevent occurrence of injury to a user's finger and occurrence of damage to the flexible display device 26 caused by an edge or a corner formed at the end portion of the free edge of the curved surface cover 120; and a bumper shape 122 formed at the top and bottom edge portions of the curved surface cover 120 so that the top and bottom edge portions of the curved surface cover 120 may prevent occurrence of damage to the out-folding image display device caused by a dropping impact when the out-folding image display device of a folded state is dropped.

As shown in FIG. 6, the case of an out-folding image display device to which the bottom open cover 110 allowing multi-folding or rolling is applied may be configured to include a pulling means 123 such as a pulling strip connected to a penetration hole formed at a predetermined portion positioning at the free edge of the curved surface cover 120 so that a user may easily unfold the portions of the bottom open cover 110 and the curved surface cover 120 stored in a multi-folded or rolled state, and since the pulling means 123 cannot be shown in FIGS. 8, 12 and 14 due to the multi-folded or rolled state, the pulling strip is not shown in the figure.

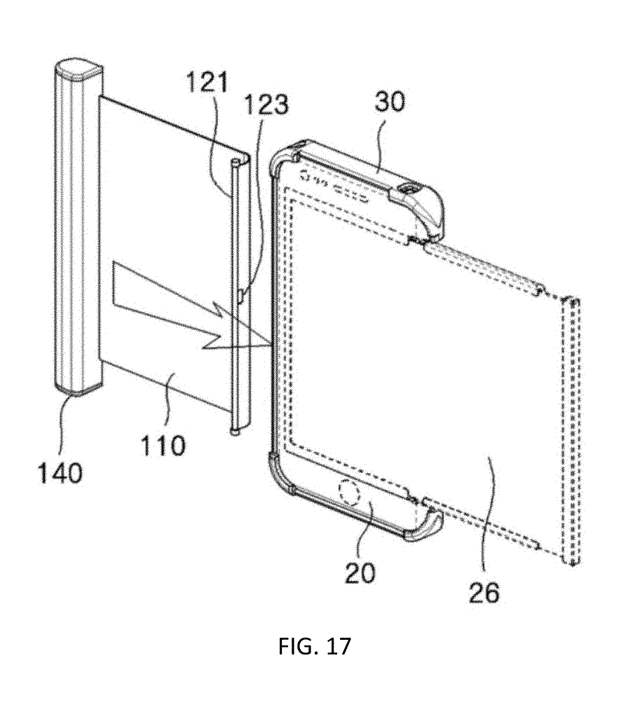

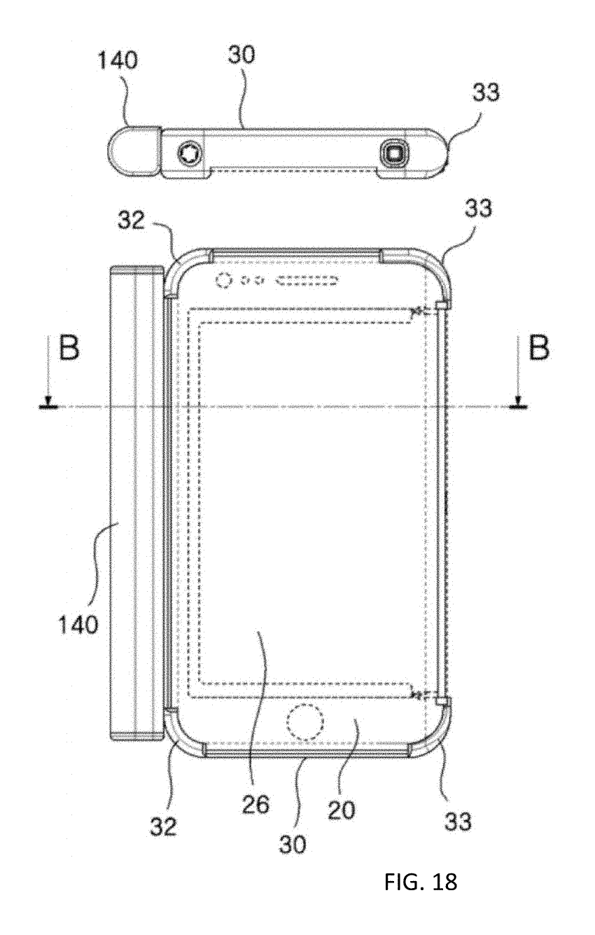

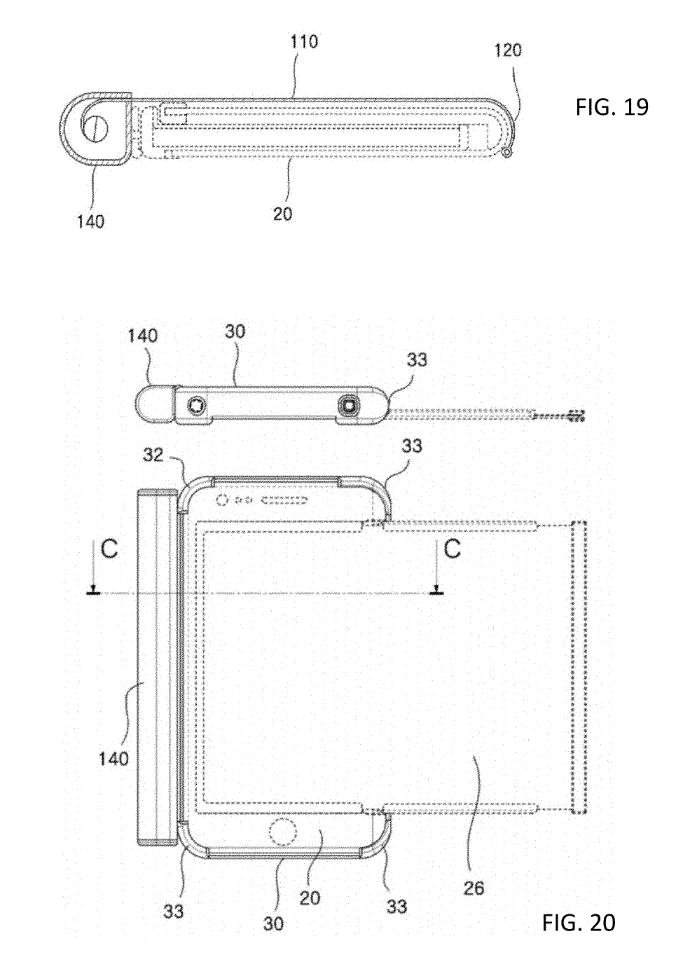

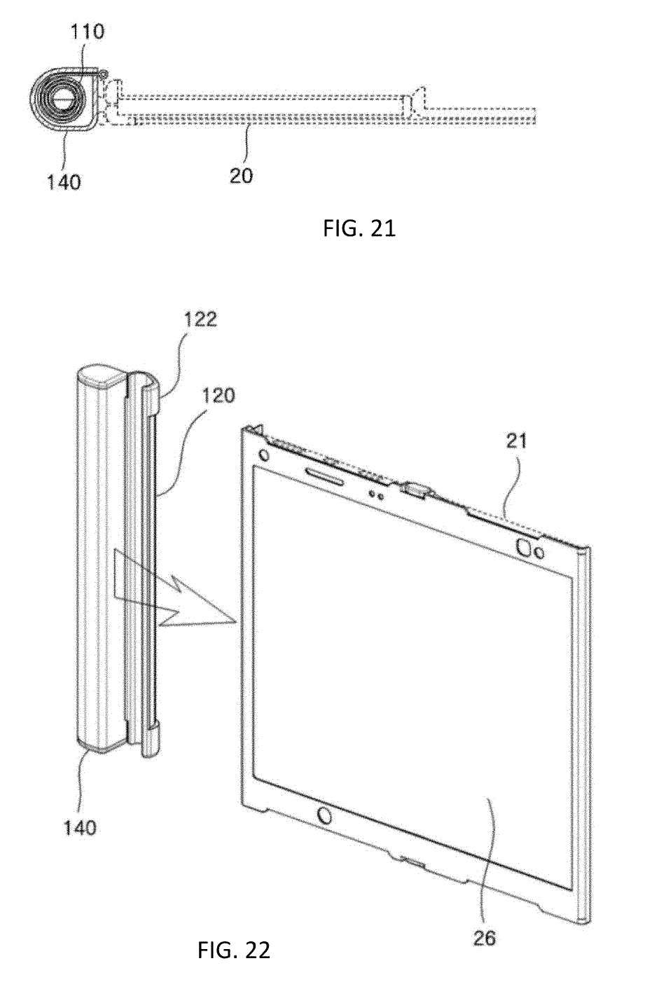

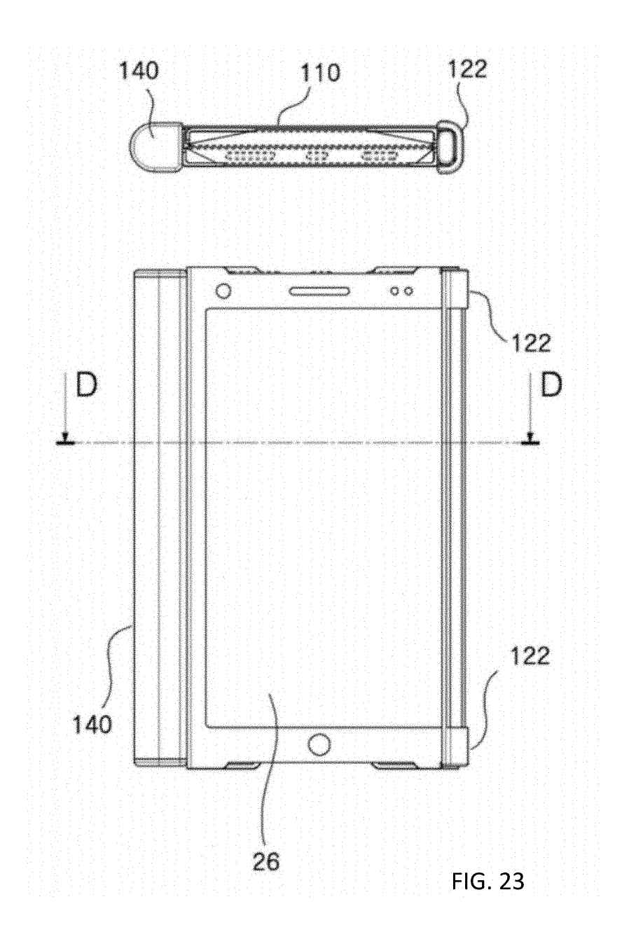

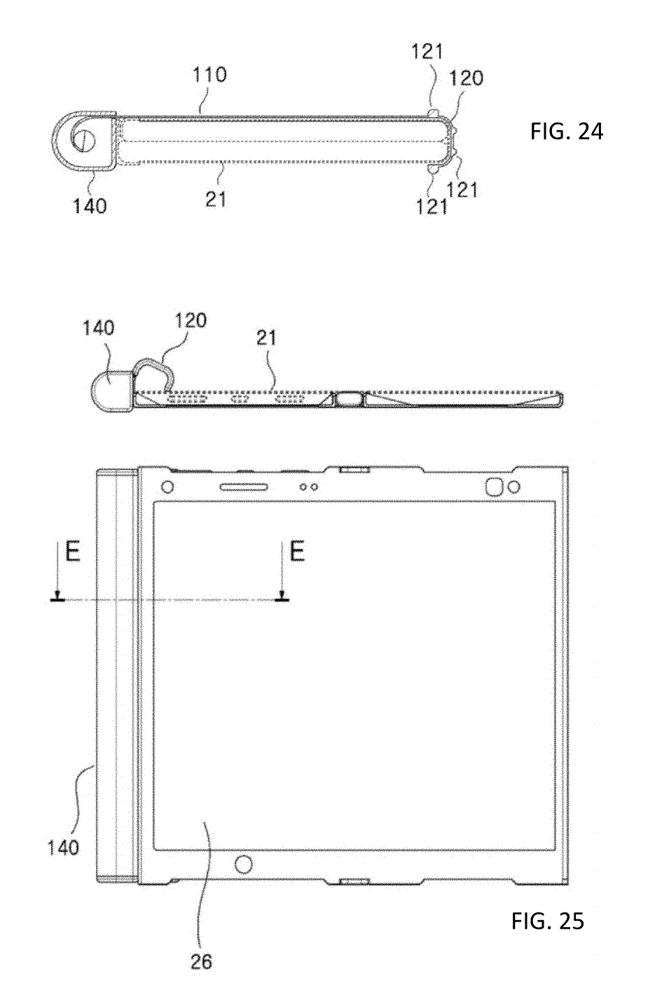

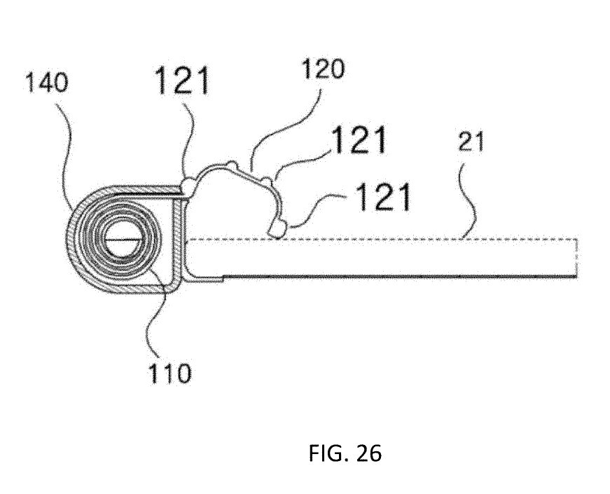

FIG. 17 is a perspective view showing a storage housing applied to an asymmetric out-folding image display device, FIG. 18 is a plan view and a front view showing a folded state of a case of an asymmetric out-folding image display device including a storage housing applied to the asymmetric out-folding image display device, FIG. 19 is a cross-sectional view showing Section B-B of FIG. 18, FIG. 20 is a plan view and a front view showing an unfolded state of a case of an asymmetric out-folding image display device including a storage housing applied to the asymmetric out-folding image display device, FIG. 21 is a cross-sectional view showing Section C-C of FIG. 20, FIG. 22 is a perspective view showing a storage housing applied to a symmetric out-folding image display device, FIG. 23 is a plan view and a front view showing a folded state of a case of a symmetric out-folding image display device including a storage housing applied to the symmetric out-folding image display device, FIG. 24 is a cross-sectional view showing Section D-D of FIG. 23, FIG. 25 is a plan view and a front view showing an unfolded state of a case of a symmetric out-folding image display device including a storage housing applied to the symmetric out-folding image display device, and FIG. 26 is a cross-sectional view showing Section E-E of FIG. 25.

As shown in FIGS. 17, 18, 20, 22, 23 and 25, in a second embodiment, which is another embodiment of the present invention, the case of an out-folding image display device may be configured to include: a storage housing 140 applied to an edge portion on the opposite side of the folding axis 25 part of the out-folding image display device having the folding axis part where folding of the flexible display device 26 occurs and having a rolling axis and a storage space for a rolling target; and a bottom open cover 110, although corresponding to the bottom surface fixing plate fixed on the opposite side of the screen display surface of a diary type case applied to the shape-invariant image display device, capable of covering the foldable and securable display part of the out-folding image display device in a folded state or maintaining a state of being rolled and stored in the storage housing 140 as an end portion of one side is connected to the rolling axis of the storage housing 140, and an end portion of the opposite side is spread to get out of the storage housing 140.

As shown in FIGS. 17, 18, 20 and 21, in a second embodiment, the case of an out-folding image display device may be configured to include: a curved surface cover 120 formed to be extended at the end portion of the free edge on the opposite side of the bottom open cover 100 connected to the rolling axis to selectively cover the curved surface shape portion of the flexible display device 26 formed when the out-folding image display device is folded in case of an unfolding state and to be sequentially rolled together with the bottom open cover 110 and stored in the storage housing 140 in a rolled state except the end portion of the free edge in case of a rolling state; and the curved surface cover 120 may be configured to include a protection frame 121 formed across the end portion of the free edge to prevent injury to a user's finger, prevent damage to the flexible display device 26, and form an end portion latch at the outside of the outlet of the storage housing 140 for an unfolding process. As shown in FIGS. 22, 23, 24 and 25, as another example of the curved surface cover 120 that can be applied to the second embodiment, the case of an out-folding image display device may be configured to include: a curved surface cover 120 formed to be extended or assembled using a separate component at the end portion of the free edge on the opposite side of the bottom open cover 100 connected to the rolling axis to selectively cover the curved surface shape portion of the flexible display device 26 formed when the out-folding image display device is folded in case of an unfolding state, and to be maintained in an unrolled state outside the storage housing 140 unlike the bottom open cover 110 in case of a rolling state; and the curved surface cover 120 may be configured to include: a protection frame 121 formed across the end portion of the free edge to prevent injury to a user's finger and prevent damage to the flexible display device 26 caused by an edge or a corner formed at the end portion of the free edge of the curved surface cover 120; and a bumper shape 122 formed at the top and bottom edges of the curved surface cover 120 so that the top and bottom edge portions of the curved surface cover 120 may prevent occurrence of damage to the out-folding image display device caused by a dropping impact when the out-folding image display device of a folded state is dropped.

As shown in FIG. 17, in the second embodiment, the case of an out-folding image display device may be configured to include a pulling means 123 such as a pulling strip connected to a penetration hole formed at a predetermined portion positioning at the free edge of the curved surface cover 120 so that a user may easily unfold the portion stored in the storage housing 140 in a rolled state, and the pulling strip is not shown in the figure.

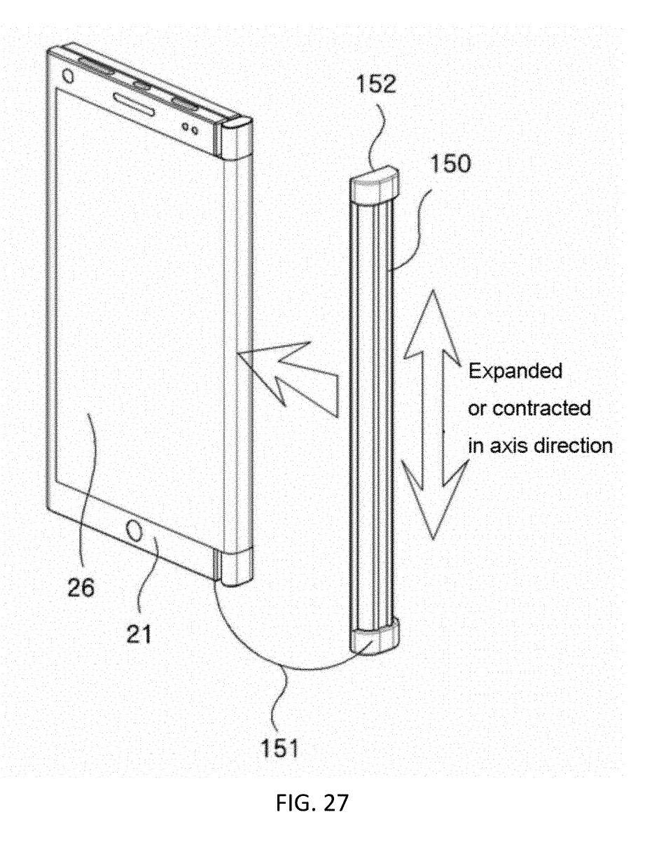

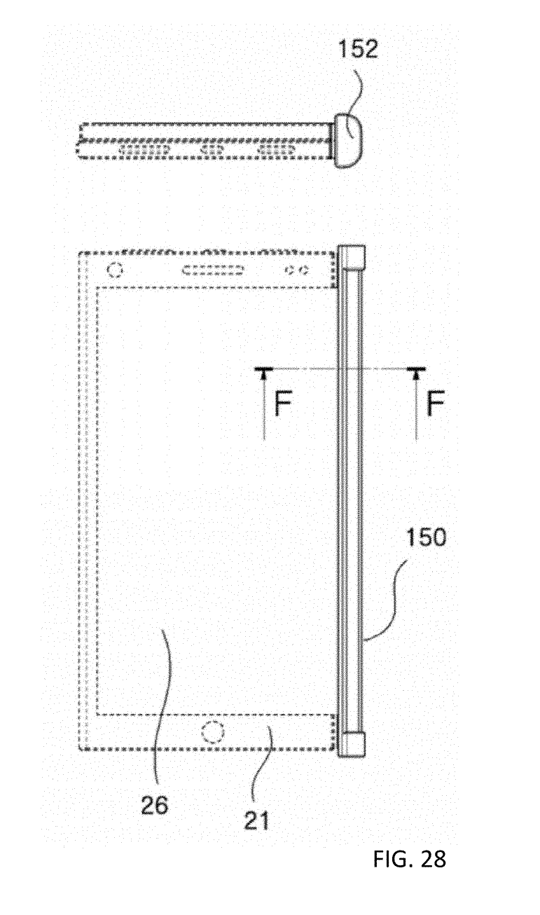

FIG. 27 is a perspective view showing an independent curved surface cover applied to a symmetric out-folding image display device, FIG. 28 is a plan view and a front view showing a folded state of a case of a symmetric out-folding image display device including an independent curved surface cover applied to the symmetric out-folding image display device, and FIG. 29 is a cross-sectional view showing Section F-F of FIG. 28.

As shown in FIGS. 27, 28 and 29, a third embodiment, which is another embodiment of the present invention, is a case of an out-folding image display device having a folding axis 25 part where folding occurs, and it includes an independent curved surface cover 150 independently applied without a separate component for protecting a screen display surface of a plane state of the out-folding image display device and for fixing the case, fixed to the folding axis 25 part when the out-folding image display device is in a folded state to selectively cover and protect the curved surface shape portion of the flexible display device 26, and released from the folding axis 25 part when the unfolded state of the out-folding image display device is changed.

In the third embodiment, the independent curved surface cover 150 may be configured to include: a bumper shape 122 formed at the edges of the curved surface cover 120 so that the edge portions of the curved surface cover 120 may prevent occurrence of damage to the out-folding image display device caused by a dropping impact when the out-folding image display device of a folded state is dropped; and a loss preventing connection strip 151, one end of which is connected to the out-folding image display device, and the other end of which is connected to the independent curved surface cover 150 so that the independent curved surface cover 150 released from the folding axis 25 part may not be separated and lost without being connected to the out-folding image display device when the unfolded state of the out-folding image display device is changed. In the third embodiment, the independent curved surface cover 150 may be configured to include an axis direction closed surface 152 formed at both ends positioning in the direction of the folding axis 25 part of the independent curved surface cover 150 by closing the top edge and the bottom edge of the independent curved surface cover 150 so that the independent curved surface cover 150 may not slide and deviate in the direction of the folding axis 25 part.

As shown in FIG. 27, as another application example of the independent curved surface cover 150 that can be applied to the third embodiment, when the independent curved surface cover 150 is released and separated from the folding axis 25 part of the out-folding image display device, both end portions of the independent curved surface cover 150 are contracted facing each other in the direction of the folding axis part to occupy a minimum space, and when the independent curved surface cover 150 is applied to be fixed to the folding axis 25 part, it may be expanded and fixed in the direction of the folding axis 25 part as the user fixes by latching an end portion and pulling the other end portion.

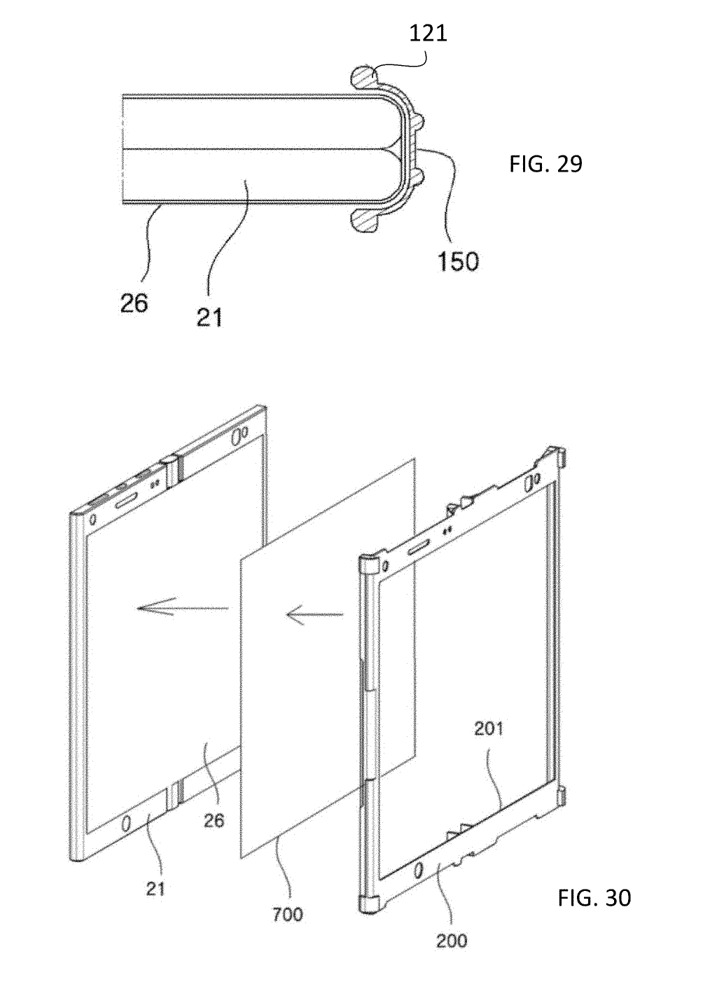

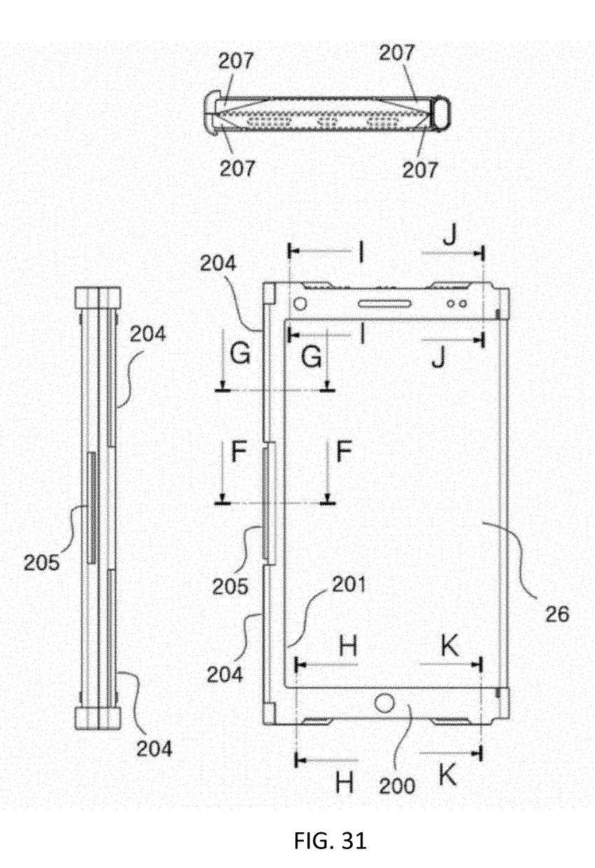

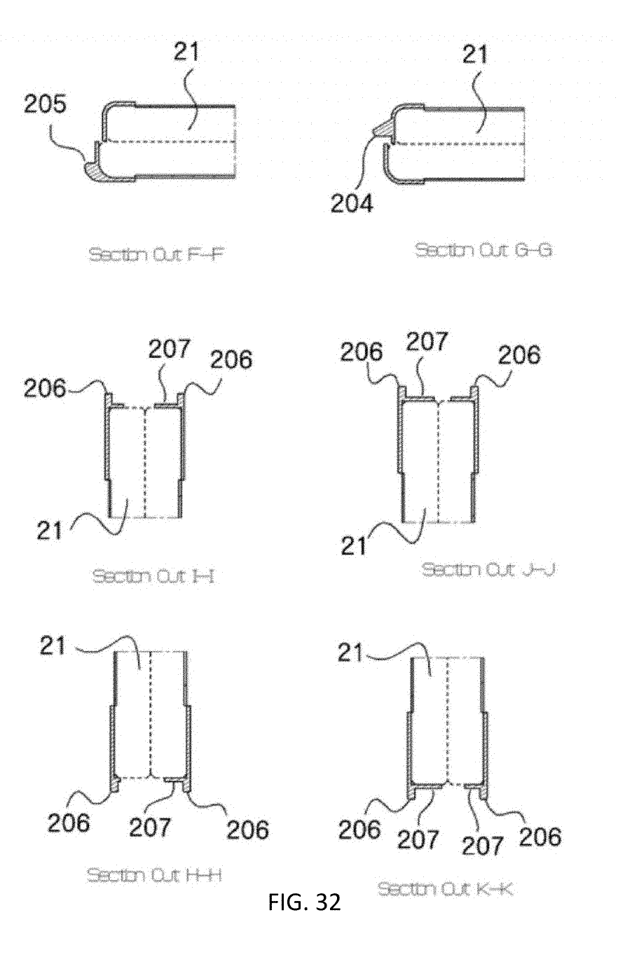

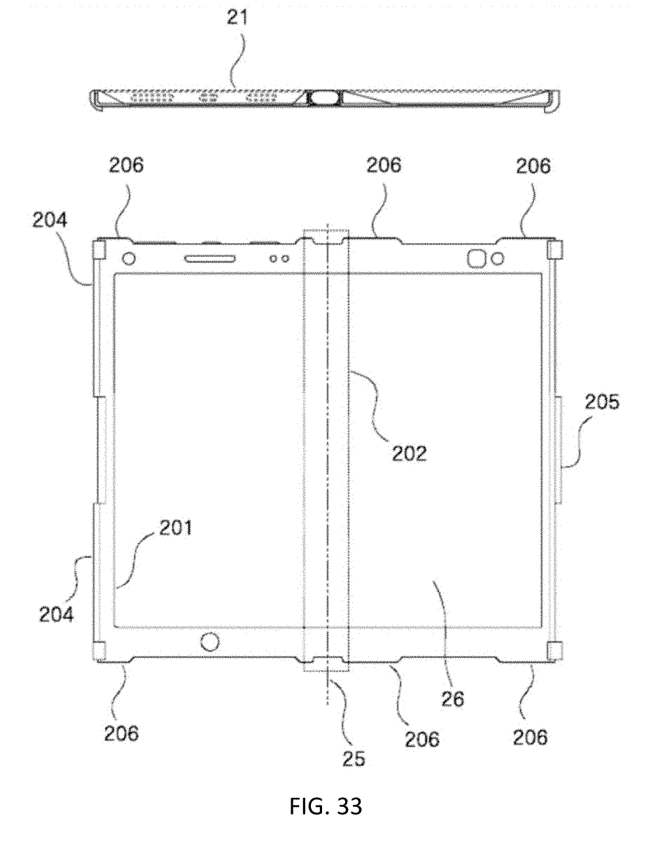

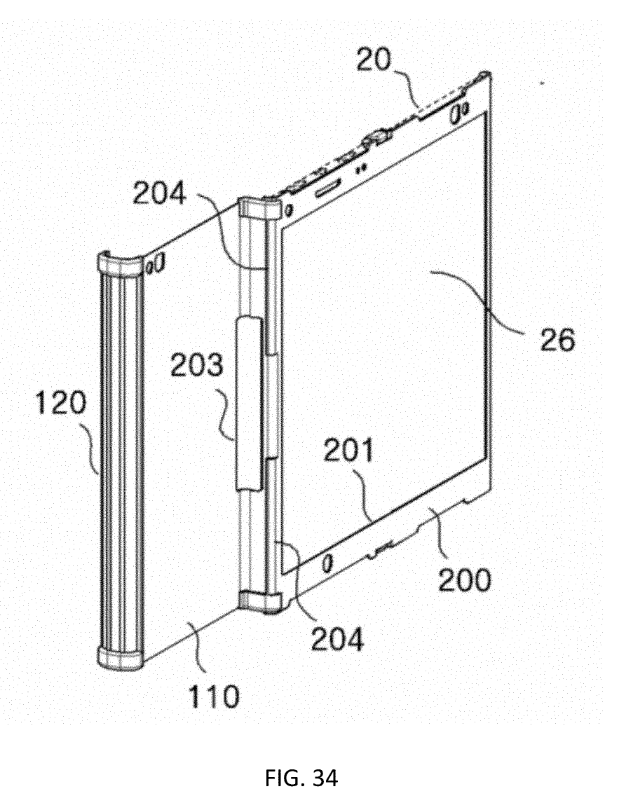

FIG. 30 is a perspective view showing an integrated front side opening cover applied to a symmetric out-folding image display device, FIG. 31 is a plan view, a side view and a front view showing a folded state of a case of a symmetric out-folding image display device including an integrated front side opening cover applied to the symmetric out-folding image display device, FIG. 32 is cross-sectional views showing Section F-F, Section G-G, Section H-H, Section I-I, Section J-J and Section K-K of FIG. 31, FIG. 33 is a plan view and a front view showing an unfolded state of a case of a symmetric out-folding image display device including an integrated front side opening cover applied to the symmetric out-folding image display device, and FIG. 34 is a perspective view showing an unfolded states of a case of a symmetric out-folding image display device including an integrated front side opening cover provided with a bottom open cover.

As shown in the figures of FIGS. 30 to 34, a fourth embodiment, which is another embodiment of the present invention, is a case of an out-folding image display device having a folding axis 25 part where folding occurs, and it is configured to include an integrated front side opening cover 200, in which a screen display surface penetration hole 201 for exposing a screen display capable area of the flexible display device 26 applied to the out-folding image display device is formed, and both portions on the left and right sides of the folding axis 25 part configuring the portions excluding the screen display surface penetration hole 201 are tightly fixed, in an integrated form, on the outer surface of the out-folding image display device to which the flexible display device 26 is fixed.

As shown in FIG. 34, in the fourth embodiment, the case of an out-folding image display device may be configured to include a bottom open cover 110 formed to be extended or separately assembled at an edge on the opposite side facing the folding axis 25 part to selectively cover the foldable and securable display part of the out-folding image display device.

In the fourth embodiment, the integrated front side opening cover 200 may be configured to include: an unfold handling penetration hole 203 formed to pass through a side positioned at an edge on the opposite side facing the folding axis 25 part of the integrated front side opening cover 200; an upper finger latching step 204 formed to be protruded at both ends of the edge where the unfold handling penetration hole 203 is formed, among the edges on the opposite side facing the folding axis 25 part, so that a finger may be easily latched to apply an unfolding force; and a lower finger latching step 205 formed on an edge where the unfold handling penetration hole 203 is not formed, among the edges on the opposite side facing the folding axis 25 part, so that remaining fingers not latched to the upper finger latching step may transfer a latching force related unfolding in the opposite direction by way of the unfold handling penetration hole 203.

As shown in FIGS. 31 and 32, in the fourth embodiment, the integrated front side opening cover 200 may be configured to include: a bumper protrusion 206 formed to have a predetermined length by extending the circumferential area of the out-folding image display device from the top and bottom corner areas of the edges facing the folding axis 25 part, among the corner portions of the integrated front side opening cover 200, toward the outside of the circumferential area of the out-folding image display device; and a bumper protrusion supporting surface 207 formed to be extended across a predetermined range in a direction perpendicular to the direction of the bumper protrusion 206 formed to be extended so that the portion starting the extended formation of the bumper protrusion 206 may be fixed to the top surface and the bottom surface of the out-folding image display device perpendicular to the folding axis 25 part, and a case capable of performing a limited bumper function may be also applied to the symmetric out-folding image display device to which the bumper case is difficult to be applied since bumper protrusions 206 are formed at the corner portions of the integrated front side opening cover 200.

As shown in FIG. 33, in the fourth embodiment, a portion related to the folding axis 25 part and corresponding to a variable circumferential area 202 where circumferential length is changed when the folding axis 25 part is folded and unfolded, among the portions of the integrated front side opening cover 200, is not directly fixed to the out-folding image display device, but indirectly fixed through directly fixed adjacent portions, absorb changes of the circumferential length.

The integrated front side opening cover 200 may be formed of an elastic material or a portion corresponding to the variable circumferential area 202 may have a wrinkle shape 208 so that the portion corresponding to the variable circumferential area 202, among the portions of the integrated front side opening cover 200, may absorb the change of the circumferential length.

As shown in FIG. 30, a fifth embodiment, which is another embodiment of the present invention, is a case of an out-folding image display device having a folding axis part where folding occurs, and it is configured to include: an integrated front side opening cover, in which a screen display surface penetration hole for exposing a screen display capable area of the flexible display device applied to the out-folding image display device is formed, and both portions on the left and right sides of the folding axis part configuring the portions excluding the screen display surface penetration hole are tightly fixed, in an integrated form, on the outer surface of the out-folding image display device to which the flexible display device is fixed; and a protection film for closing the screen display surface penetration hole of the integrated front side opening cover, being fixed to the circumference of the screen display surface penetration hole, protecting the flexible display device, and allowing transmission of the display screen.

In the fifth embodiment, the protection film 700 may be formed of an elastic material absorb changes of the circumferential length when the folding axis 25 part is folded and unfolded.

In the fifth embodiment, the integrated front side opening cover 200 is the same as the integrated front side opening cover 200 of the fourth embodiment.

As shown in FIGS. 31, 32 and 33, the integrated front side opening cover 200 may be configured to include:

an unfold handling penetration hole 203 formed to pass through a side positioned at an edge on the opposite side facing the folding axis 25 part of the integrated front side opening cover 200,

an upper finger latching step 204 formed to be protruded at both ends of the edge where the unfold handling penetration hole 203 is formed, among the edges on the opposite side facing the folding axis 25 part, so that a finger may be easily latched to apply an unfolding force; and a lower finger latching step 205 formed on an edge where the unfold handling penetration hole 203 is not formed, among the edges on the opposite side facing the folding axis 25 part, so that remaining fingers not latched to the upper finger latching step may transfer a latching force related unfolding in the opposite direction by way of the unfold handling penetration hole 203. In the fifth embodiment, the integrated front side opening cover 200 may be configured to include: a bumper protrusion 206 formed to have a predetermined length by extending the circumferential area of the out-folding image display device from the top and bottom corner areas of the edges facing the folding axis 25 part, among the corner portions of the integrated front side opening cover 200, toward the outside of the circumferential area of the out-folding image display device; and a bumper protrusion supporting surface 207 formed to be extended across a predetermined range in a direction perpendicular to the direction of the bumper protrusion 206 formed to be extended so that the portion starting the extended formation of the bumper protrusion 206 may be fixed to the top surface and the bottom surface of the out-folding image display device perpendicular to the folding axis 25 part.

In the fifth embodiment, a portion related to the folding axis 25 part and corresponding to a variable circumferential area 202 where circumferential length is changed when the folding axis 25 part is folded and unfolded, among the portions of the integrated front side opening cover 200, is not directly fixed to the out-folding image display device, but indirectly fixed through directly fixed adjacent portions, absorb changes of the circumferential length. The integrated front side opening cover 200 may be formed of an elastic material so that the portion corresponding to the variable circumferential area 202, among the portions of the integrated front side opening cover 200, may absorb the change of the circumferential length.

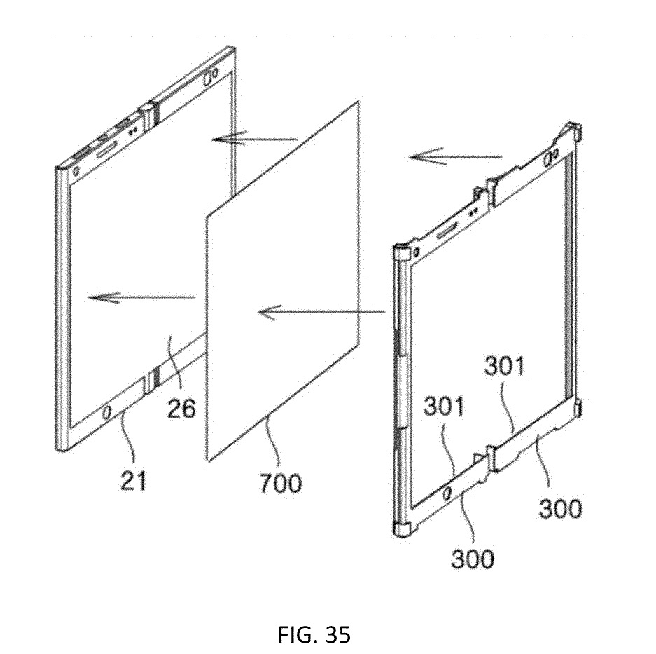

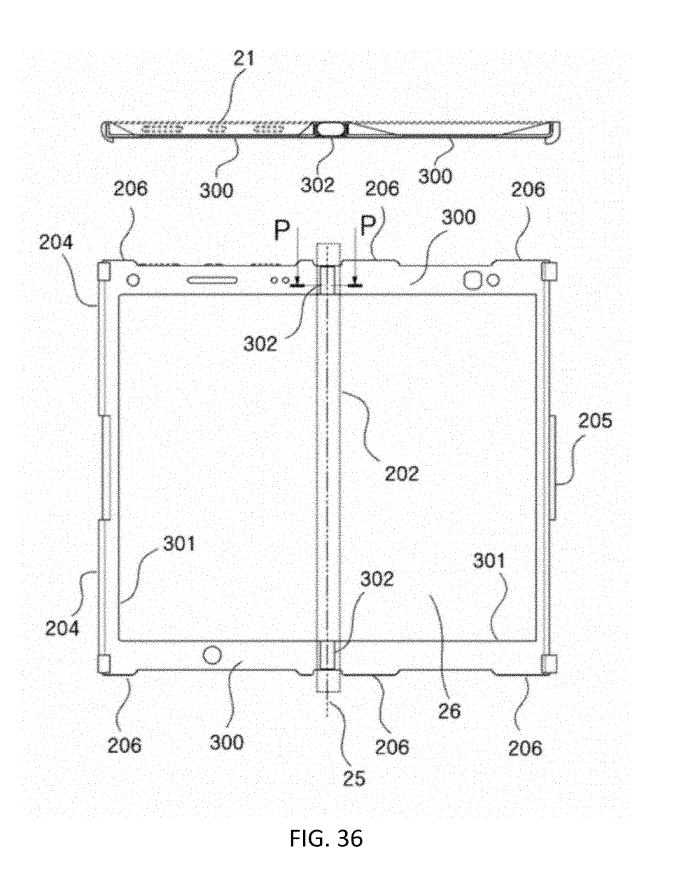

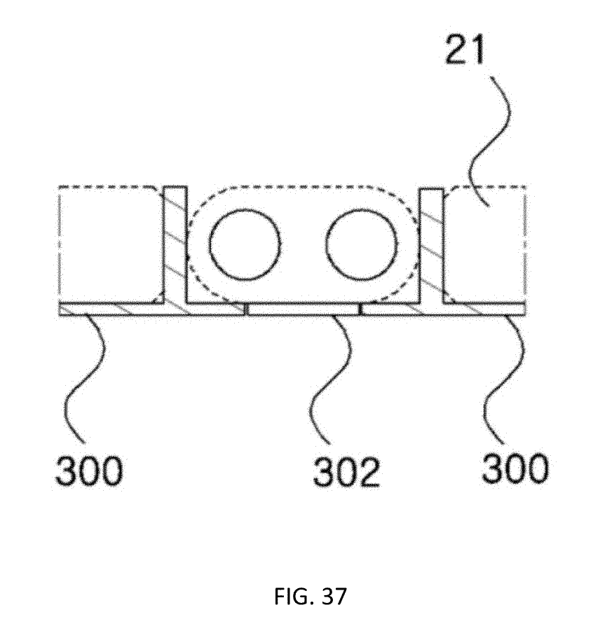

FIG. 35 is a perspective view showing a horizontally separable front cover applied to a symmetric out-folding image display device, FIG. 36 is a plan view and a front view showing an unfolded state of a case of a symmetric out-folding image display device including a horizontally separable front cover applied to the symmetric out-folding image display device, and FIG. 37 is a cross-sectional view showing Section L-L of FIG. 36. FIG. 37 is a plan view and a front view showing an unfolded state of a case of a symmetric out-folding image display device including a horizontally separable front cover applied to the symmetric out-folding image display device.

As shown in FIGS. 35, 36 and 37, a sixth embodiment, which is another embodiment of the present invention, is a case of an out-folding image display device having a folding axis 25 part where folding occurs, and it may be configured to include: a horizontally separable front cover 300, in which a screen display surface opening 301 for exposing a screen display capable area of the flexible display device 26 applied to the out-folding image display device is formed in both portions on the left and right sides of the folding axis 25 part, and the portions excluding the screen display surface opening 301 are tightly fixed, while the portions on the left and right sides of the folding axis part are separated, on the outer surface of the out-folding image display device to which the flexible display device is fixed; and a variable connection cover 302 applied to the variable circumferential area 202 where circumferential length is changed when the folding axis 25 part is folded and unfolded, which is a portion to which the horizontally separable front cover 300 is not applied.

In the same manner as shown in FIG. 34 of the fifth embodiment, in the sixth embodiment, the case of an out-folding image display device may be configured to include a bottom open cover 110 formed to be extended or separately assembled at an edge on the opposite side facing the folding axis 25 part to selectively cover the foldable and securable display part of the out-folding image display device, and since this has nothing to do with a method for treating the variable circumferential area 202 portion generating a difference between the fifth embodiment and the sixth embodiment, description thereof will be omitted on the basis of FIG. 34 of the fifth embodiment.

In the same manner as shown in FIG. 34 of the fifth embodiment, in the sixth embodiment, the horizontally separable front side opening cover may be configured to include: an unfold handling penetration hole 203 formed to pass through a side positioned at an edge on the opposite side facing the folding axis 25 part of the horizontally separable front side opening cover; an upper finger latching step 204 formed to be protruded at both ends of the edge where the unfold handling penetration hole 203 is formed, among the edges on the opposite side facing the folding axis 25 part, so that a finger may be easily latched to apply an unfolding force; and a lower finger latching step 205 formed on an edge where the unfold handling penetration hole 203 is not formed, among the edges on the opposite side facing the folding axis 25 part, so that remaining fingers not latched to the upper finger latching step 204 may transfer a latching force related unfolding in the opposite direction by way of the unfold handling penetration hole 203.

In the sixth embodiment, the horizontally separable front side opening cover may be configured to include: a bumper protrusion 206 formed to have a predetermined length by extending the circumferential area of the out-folding image display device from the top and bottom corner areas of the edges facing the folding axis 25 part, among the corner portions of the horizontally separable front side opening cover, toward the outside of the circumferential area of the out-folding image display device; and a bumper protrusion supporting surface 207 formed to be extended across a predetermined range in a direction perpendicular to the direction of the bumper protrusion 206 formed to be extended so that the portion starting the extended formation of the bumper protrusion 206 may be fixed to the top surface and the bottom surface of the out-folding image display device perpendicular to the folding axis 25 part.

As shown in FIGS. 36 and 37, in the sixth embodiment, the variable connection cover 302 is applied between both ends of the horizontally separable front side opening cover of an isolated state and may be formed of an elastic material absorb changes of the circumferential length when the folding axis 25 part is folded and unfolded.

As shown in FIG. 35, a seventh embodiment, which is another embodiment of the present invention, is a case of an out-folding image display device having a folding axis 25 part where folding occurs, and it may be configured to include: a horizontally separable front cover 300, in which a screen display surface opening 301 for exposing a screen display capable area of the flexible display device 26 applied to the out-folding image display device is formed in the portions on the left and right sides of the folding axis 25 part, and the portions excluding the screen display surface opening 301 are tightly fixed, while the portions on the left and right sides of the folding axis part are separated, on the outer surface of the out-folding image display device to which the flexible display device is fixed; a variable connection cover 302 applied to the variable circumferential area 202 where circumferential length is changed when the folding axis 25 part is folded and unfolded, which is a portion to which the horizontally separable front cover 300 is not applied; and a protection film 700 for closing a virtual screen display capable area formed by the screen display surface openings 301 on both sides separated by the fixing axis 25, being fixed to the circumference of the screen display surface openings 301 on both sides, protecting the flexible display device 26, and allowing transmission of the display screen.

In the seventh embodiment, the protection film 700 may be formed of an elastic material absorb changes of the circumferential length when the folding axis 25 part is folded and unfolded.

In the seventh embodiment, the horizontally separable front cover 300 may be configured to include: an unfold handling penetration hole 203 formed to pass through a side positioned at an edge on the opposite side facing the folding axis 25 part of the horizontally separable front side opening cover 300; an upper finger latching step 204 formed to be protruded at both ends of the edge where the unfold handling penetration hole 203 is formed, among the edges on the opposite side facing the folding axis 25 part, so that a finger may be easily latched to apply an unfolding force; and a lower finger latching step 205 formed on an edge where the unfold handling penetration hole 203 is not formed, among the edges on the opposite side facing the folding axis 25 part, so that remaining fingers not latched to the upper finger latching step 204 may transfer a latching force related unfolding in the opposite direction by way of the unfold handling penetration hole 203. In the same manner as shown in FIG. 32 of the fourth embodiment, in the seventh embodiment, the horizontally separable front cover 300 may be configured to include: a bumper protrusion 206 formed to have a predetermined length by extending the circumferential area of the out-folding image display device from the top and bottom corner areas of the edges facing the folding axis 25 part, among the corner portions of the horizontally separable front cover 300, toward the outside of the circumferential area of the out-folding image display device; and a bumper protrusion supporting surface 207 formed to be extended across a predetermined range in a direction perpendicular to the direction of the bumper protrusion 206 formed to be extended so that the portion starting the extended formation of the bumper protrusion 206 may be fixed to the top surface and the bottom surface of the out-folding image display device perpendicular to the folding axis 25 part.

In the same manner as the sixth embodiment, in the seventh embodiment, the variable connection cover 302 is applied between both ends of the horizontally separable front side opening cover of an isolated state and may be formed of an elastic material absorb changes of the circumferential length when the folding axis 25 part is folded and unfolded.

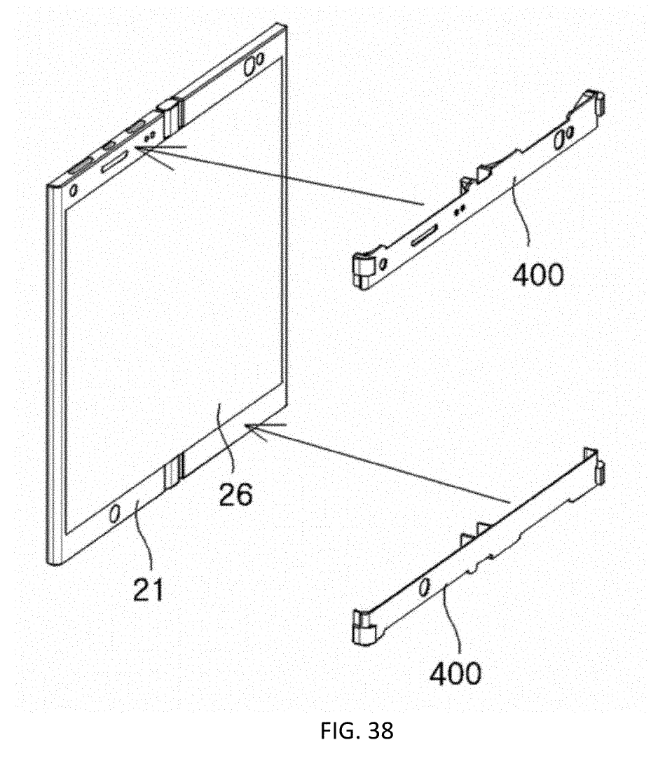

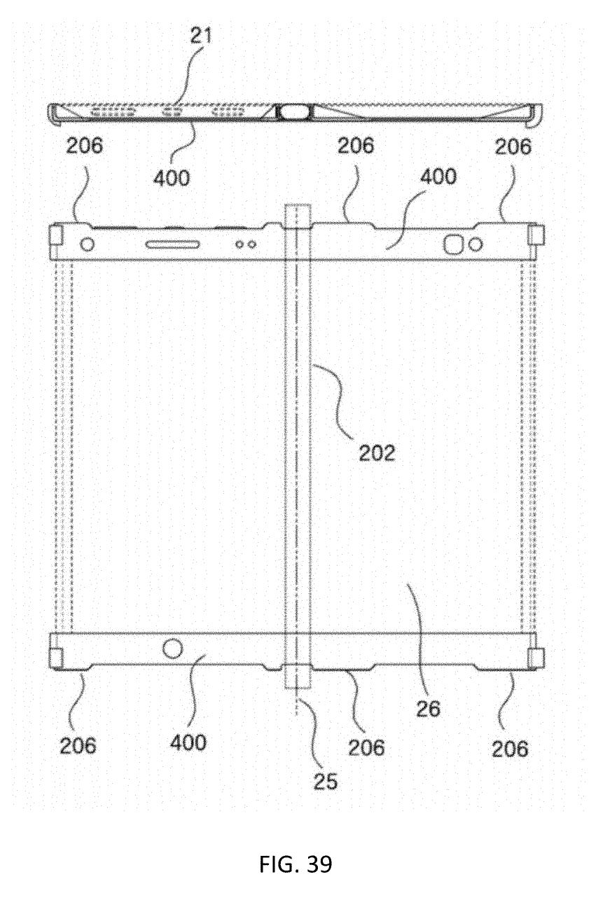

FIG. 38 is a perspective view showing a vertically separable front cover applied to a symmetric out-folding image display device, and FIG. 39 is a plan view and a front view showing an unfolded state of a case of a symmetric out-folding image display device including a vertically separable front cover applied to the symmetric out-folding image display device.

As shown in FIGS. 38 and 39, an eighth embodiment, which is another embodiment of the present invention, is a case of an out-folding image display device having a folding axis 25 part where folding occurs, and it may be configured to include a vertically separable front cover 400, in which a portion formed to be separated into an upper portion and a lower portion, as the area between the upper and lower edges of the screen display capable area is extended and removed to expose the screen display capable area of the flexible display device 26 applied to the out-folding image display device, is tightly fixed on the outer surface of the out-folding image display device to which the flexible display device 26 is fixed while the upper and lower edges separated.

In the eighth embodiment, a portion related to the folding axis 25 part and corresponding to a variable circumferential area 202 where circumferential length is changed when the folding axis 25 part is folded and unfolded, among the portions of the vertically separable front cover 400, is not directly fixed to the out-folding image display device, but indirectly fixed through directly fixed adjacent portions, absorb changes of the circumferential length. In the eighth embodiment, the vertically separable front cover 400 may be formed of an elastic material or a portion corresponding to the variable circumferential area 202 may have a wrinkle shape 208 so that the portion corresponding to the variable circumferential area 202, among the portions of the vertically separable front cover 400, may absorb the change of the circumferential length.

In the eighth embodiment, the vertically separable front cover 400 is configured to include: a bumper protrusion 206 formed to have a predetermined length by extending the circumferential area of the out-folding image display device from the top and bottom corner areas of the edges facing the folding axis 25 part, among the corner portions of the vertically separable front cover 400, toward the outside of the circumferential area of the out-folding image display device; and a bumper protrusion supporting surface 207 formed to be extended across a predetermined range in a direction perpendicular to the direction of the bumper protrusion 206 formed to be extended so that the portion starting the extended formation of the bumper protrusion 206 may be fixed to the top surface and the bottom surface of the out-folding image display device perpendicular to the folding axis 25 part.

In the eighth embodiment, the case of an out-folding image display device is configured to include: an independent curved surface cover 150 fixed to the folding axis 25 part when the out-folding image display device is in a folded state to selectively cover and protect the curved surface shape portion of the flexible display device 26 and released from the folding axis 25 part when the unfolded state of the out-folding image display device is changed; and a loss preventing connection strip 151, one end of which is connected to the independent curved surface cover 150, and the other end of which is connected to the vertically separable front cover 400 or the out-folding image display device.

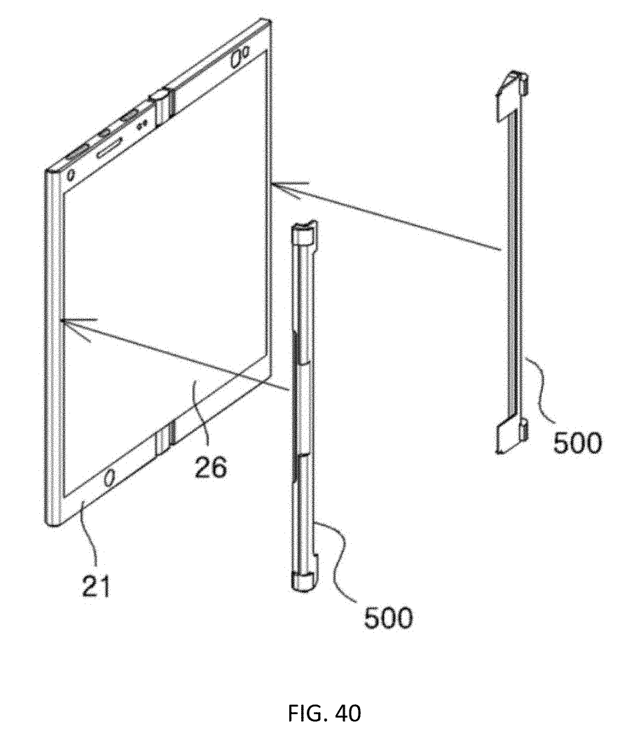

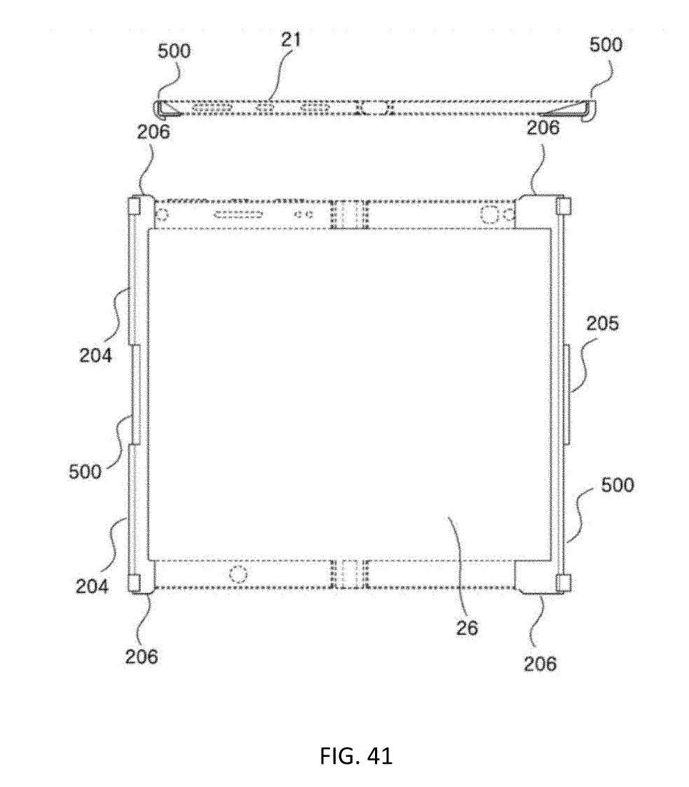

FIG. 40 is a perspective view showing an edge separable cover applied to a symmetric out-folding image display device, and FIG. 41 is a plan view and a front view showing an unfolded state of a case of a symmetric out-folding image display device including an edge separable cover applied to the symmetric out-folding image display device.

As shown in FIGS. 40 and 41, a ninth embodiment, which is another embodiment of the present invention, is a case of an out-folding image display device having a folding axis 25 part where folding occurs, and it is configured to include an edge separable cover 500 tightly fixed to the adjacent portions of facing edges positioned on the opposite sides of the folding axis 25 part of the out-folding image display device in a separated state to expose the screen display capable area of the flexible display device 26 applied to the out-folding image display device.

In the ninth embodiment, the edge separable cover 500 is configured to include a finger latching shape 501 formed on an edge of one side, among the edges on the opposite sides facing the folding axis 25 part of the edge separable cover 500, so that a finger may be easily latched to apply an unfolding force and also formed on the other edge of the opposite sides facing the folding axis 25 part so that unlatched remaining fingers may transfer a latching force related unfolding in the opposite direction.

In the ninth embodiment, the edge separable cover 500 is configured to include: a bumper protrusion 206 formed to have a predetermined length by extending the circumferential area of the out-folding image display device from the top and bottom corner areas of the edges facing the folding axis 25 part, among the corner portions of the edge separable cover 500, toward the outside of the circumferential area of the out-folding image display device; and a bumper protrusion supporting surface 207 formed to be extended across a predetermined range in a direction perpendicular to the direction of the bumper protrusion 206 formed to be extended so that the portion starting the extended formation of the bumper protrusion 206 may be fixed to the top surface and the bottom surface of the out-folding image display device perpendicular to the folding axis 25 part.

In the ninth embodiment, the case of an out-folding image display device is configured to include: an independent curved surface cover 120 or 150 fixed to the folding axis 25 part when the out-folding image display device is in a folded state to selectively cover and protect the curved surface shape portion of the flexible display device 26 and released from the folding axis 25 part when the unfolded state of the out-folding image display device is changed; and a loss preventing connection strip 151, one end of which is connected to the independent curved surface cover 120 or 150, and the other end of which is connected to the edge separable cover 500 or the out-folding image display device.

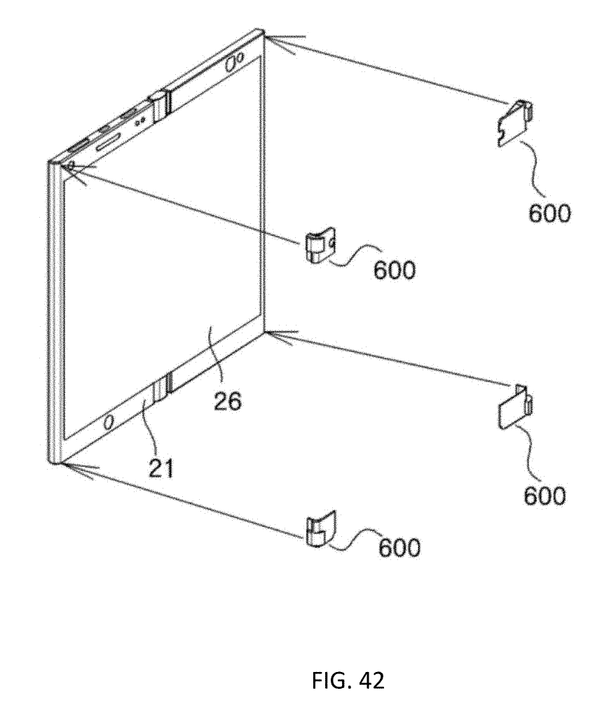

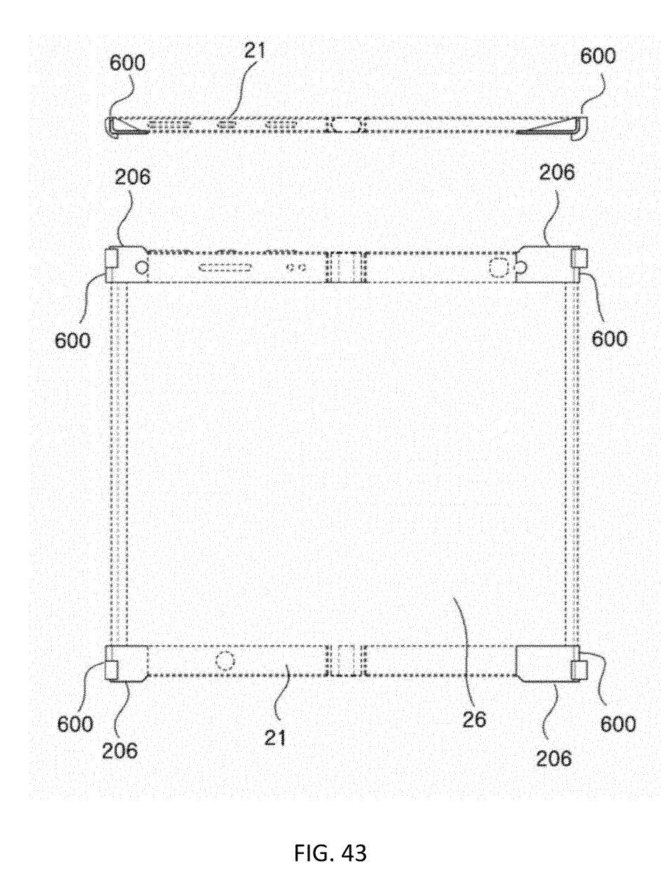

FIG. 42 is a perspective view showing a corner separable cover applied to a symmetric out-folding image display device, and FIG. 43 is a plan view and a front view showing an unfolded state of a case of a symmetric out-folding image display device including a corner separable cover applied to the symmetric out-folding image display device.

As shown in FIGS. 42 and 43, a tenth embodiment, which is another embodiment of the present invention, is a case of an out-folding image display device having a folding axis 25 part where folding occurs, and it is configured to include a corner separable cover 600 tightly fixed to the upper and lower corner portions of facing edges positioned on the opposite sides of the folding axis 25 part of the out-folding image display device in a separated state to expose the screen display capable area of the flexible display device 26 applied to the out-folding image display device.

In the tenth embodiment, the corner separable cover 600 is configured to include: a bumper protrusion 206 formed to have a predetermined length by extending the circumferential area of the out-folding image display device from the top and bottom corner areas of the edges facing the folding axis 25 part, among the corner portions of the corner separable cover 600, toward the outside of the circumferential area of the out-folding image display device; and a bumper protrusion supporting surface 207 formed to be extended across a predetermined range in a direction perpendicular to the direction of the bumper protrusion 206 formed to be extended so that the portion starting the extended formation of the bumper protrusion 206 may be fixed to the top surface and the bottom surface of the out-folding image display device perpendicular to the folding axis 25 part.

In the tenth embodiment, the case of an out-folding image display device is configured to include: an independent curved surface cover 150 fixed to the folding axis 25 part when the out-folding image display device is in a folded state to selectively cover and protect the curved surface shape portion of the flexible display device 26 and released from the folding axis 25 part when the unfolded state of the out-folding image display device is changed; and a loss preventing connection strip 151, one end of which is connected to the independent curved surface cover 150, and the other end of which is connected to the corner separable cover 600 or the out-folding image display device.

While the embodiments of the present invention have been described with reference to the accompanying drawings, it will be understood by those skilled in the art that the present invention may be embodied in other specific forms without departing from the spirit and essential characteristics thereof. The present embodiments described above are therefore to be considered in all respects as illustrative and not restrictive.

1-36. (canceled)

37. A protective case of an out-folding image display device having a flexible display device comprising a fixed screen display part fixed on a front surface of the image display device, a folding axis part that can be folded along a side surface of the image display device, and a foldable and securable display part that can be secured on a rear surface of the image display device or unfolded from the rear surface of the image display device,
the protective case comprising a protective case body fixed to the folding axis part while the flexible display device is in a folded and secured state to cover and protect the folding axis part, and released from the folding axis part while the flexible display device is in an unfolded state.

38. The protective case according to claim 37, wherein a bumper for preventing damage when the flexible display device is dropped in a folded state is provided on each edge of the protective case body.

39. The protective case according to claim 37, further comprising a loss preventing connection strip for preventing loss of the protective case while the flexible display device is in an unfolded state,
wherein an end of the loss preventing connection strip is connected to the out-folding image display device, and an end on an opposite side is connected to the protective case body.

40. The edge cover case according to claim 37, wherein an axis direction closed surface is formed at both ends of the protective case body by closing both end edges of the protective case so that the protective case body may not deviate to a length direction of the folding axis part.

41. The edge cover case according to claim 37, wherein the protective case body is formed of a material contractible and expandable in a length direction of the folding axis part to minimize a volume in a state of being released and separated from the folding axis part of the out-folding image display device.
